(19) United States
(12) Patent Application Publication
(10) Pub. No.: US 2023/0308228 A1
(43) Pub. Date: Sep. 28, 2023

(54) TIME AND CODE DOMAIN COVERAGE ENHANCEMENTS

(71) Applicant: InterDigital Patent Holdings, Inc., Wilmington, DE (US)

(72) Inventors: Faris Alfarhan, Montreal (CA); Aata El Hamss, Laval (CA); Fumihiro Hasegawa, Westmount (CA); Paul Marinier, Brossard (CA)

(73) Assignee: InterDigital Patent Holdings, Inc., Wilmington, DE (US)

(21) Appl. No.: 18/006,944

(22) PCT Filed: Aug. 5, 2021
(86) PCT No.: PCT/US2021/044728

§ 371 Date: Jan. 26, 2023

Related U.S. Application Data
(60) Provisional application No. 63/185,901, filed on May 7, 2021.
(60) Provisional application No. 63/167,883, filed on Mar. 30, 2021.
(60) Provisional application No. 63/136,514, filed on Jan. 12, 2021.
(60) Provisional application No. 63/061,491, filed on Aug. 5, 2020.

(51) Int. Cl. H04L 1/1867

(52) U.S. Cl. CPC H04L 1/1887

(57) ABSTRACT

Systems methods and devices for transmitting a transport block (TB) over multiple slots. A first grant associated with a hybrid automatic repeat request (HARQ) process in a first set of slots is received. A first subset of the first set of slots is determined to be available, and a second subset of the first set of slots is determined to be unavailable, for uplink transmission. The TB is segmented into a first segment and a second segment in response to the determination. The first segment is transmitted in the first subset of the first set of slots. A second grant associated with the HARQ process is received to transmit the TB in a second set of slots. The second segment of the TB is transmitted in the second set of slots.

### CROSS-REFERENCE TO RELATED APPLICATIONS

This application claims the benefit of U.S. Provisional Application No. 63/061,491, filed Aug. 5, 2020, U.S. Provisional Application No. 63/136,514, filed Jan. 12, 2021, U.S. Provisional Application No. 63/167,883, filed Mar. 30, 2021, and U.S. Provisional Application No. 63/185,901, filed May 7, 2021, the contents of which are incorporated herein by reference.

### BACKGROUND

In New Radio (NR), a WTRU can transmit the same transport block (TB) on multiple consecutive slots. A grant for the same TB may be repeated across up to eight slots.

### SUMMARY

Some implementations provide systems methods and devices for transmitting a transport block (TB) over multiple slots. A first grant associated with a hybrid automatic repeat request (HARQ) process in a first set of slots is received. A first subset of the first set of slots is determined to be available, and a second subset of the first set of slots is determined to be unavailable, for uplink transmission. The TB is segmented into a first segment and a second segment in response to the determination. The first segment is transmitted in the first subset of the first set of slots. A second grant associated with the HARQ process is received to transmit the TB in a second set of slots. The second segment of the TB is transmitted in the second set of slots.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a block diagram which illustrates an example block coding scheme;

FIG. 3 is a graph reflecting cell throughput for different numbers of VoIP users per cell;

FIG. 4 is a diagram illustrating nominal and actual slots for an example multi-slot PUSCH;

FIG. 5 is a block diagram illustrating an example implementation including outer coding between MAC and PHY;

FIG. 6 is a block diagram illustrating an example implementation including outer coding after channel encoding;

FIG. 7 is a block diagram illustrating an example implementation including orthogonal coding after modulation and channel encoding;

FIG. 8 is a block diagram illustrating an example implementation including orthogonal coding after channel encoding;

FIG. 9 is a block diagram illustrating example outer coding between MAC and PHY;

FIG. 10 is a block diagram illustrating example outer coding after channel encoding;

FIG. 11 is a block diagram illustrating example orthogonal coding after modulation and channel encoding;

FIG. 12 is a block diagram illustrating example orthogonal coding after channel encoding;

FIG. 13 is a block diagram illustrating example transmissions of a TB over multiple slots in a time domain duplex (TDD) case;

FIG. 14 is a block diagram illustrating example transmissions of a TB over multiple slots in a frequency domain duplex (FDD) case; and

FIG. 15 is a flow chart illustrating an example method for transmitting a TB over multiple slots.

### DETAILED DESCRIPTION

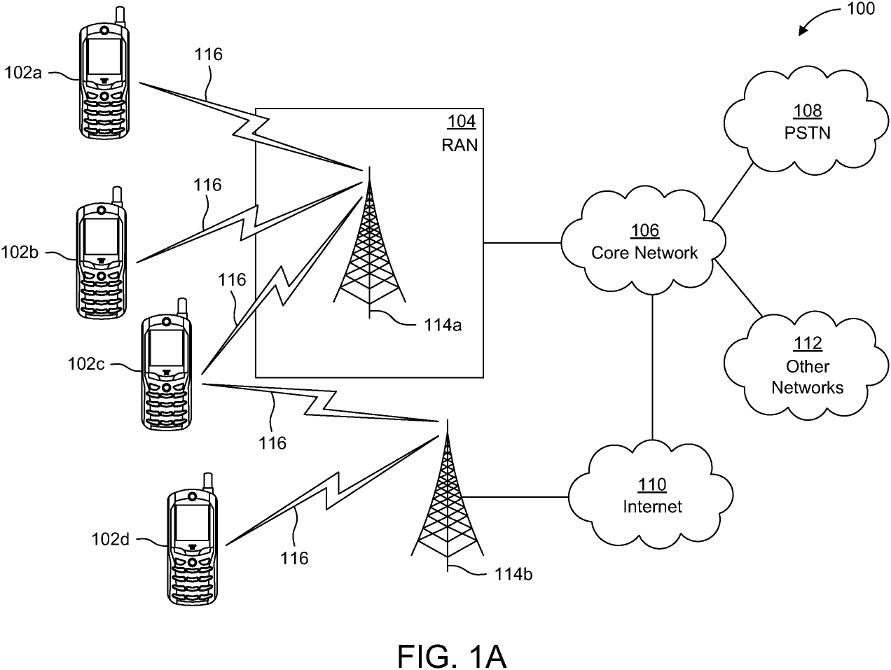

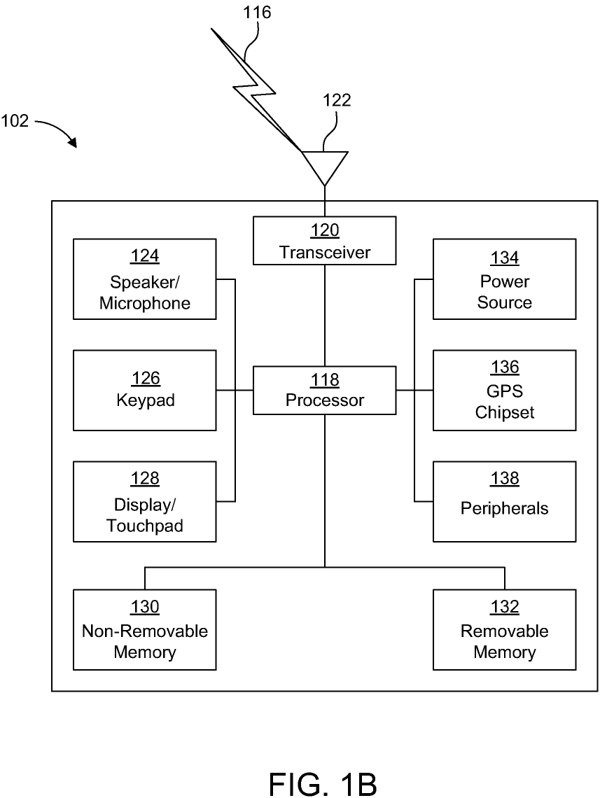

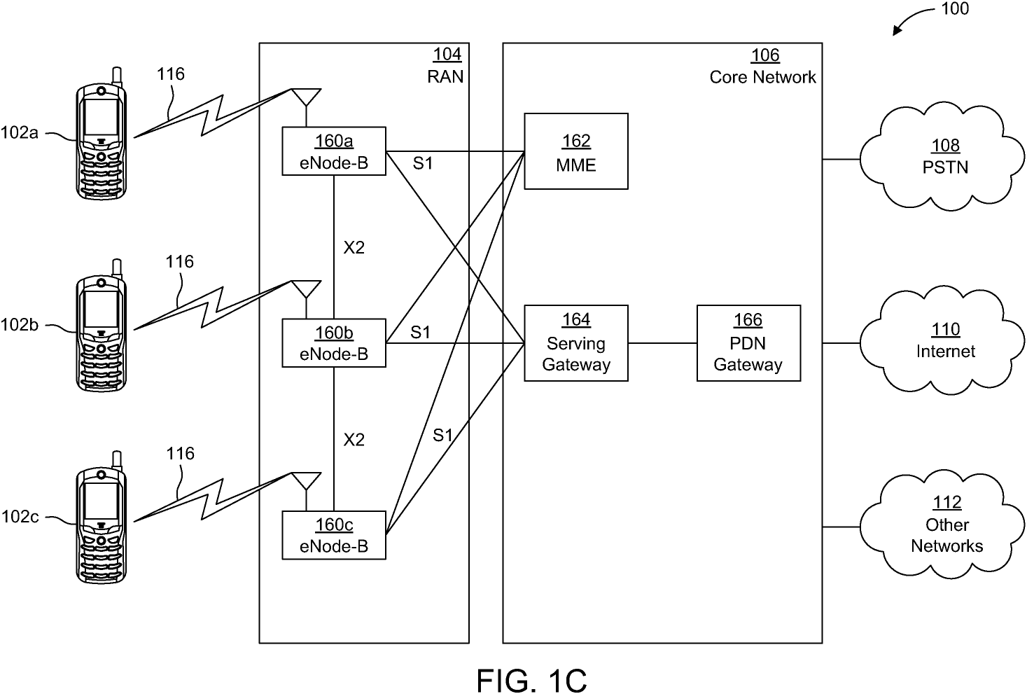

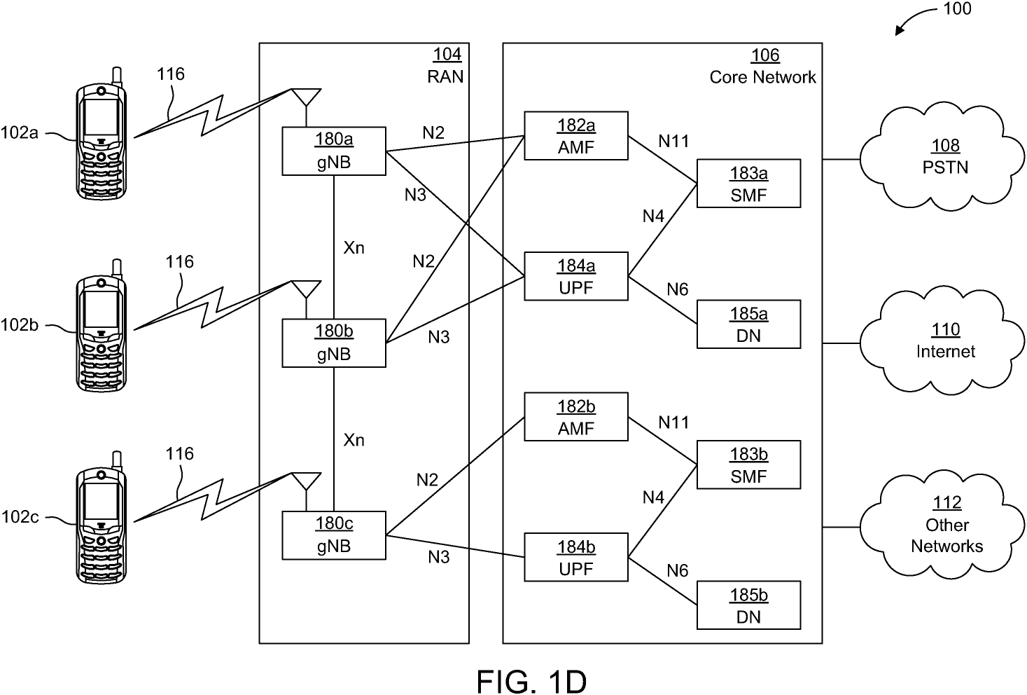

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102cwith access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a,184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Some implementations provide systems methods and devices for transmitting a transport block (TB) over multiple slots. A first grant associated with a hybrid automatic repeat request (HARQ) process in a first set of slots is received. A first subset of the first set of slots is determined to be available, and a second subset of the first set of slots is determined to be unavailable, for uplink transmission. The TB is segmented into a first segment and a second segment in response to the determination. The first segment is transmitted in the first subset of the first set of slots. A second grant associated with the HARQ process is received to transmit the TB in a second set of slots. The second segment of the TB is transmitted in the second set of slots.

Some implementations provide a method for transmission scheduling implemented in a wireless transmit/receive unit. A medium access control (MAC) protocol data unit (PDU) is split into a plurality of different coded PDU segments. The coded PDU segments are mapped to a plurality of different transmission occasions associated with different hybrid automatic repeat request (HARQ) process identifiers (PID). The coded PDU segments are transmitted on the different transmission occasions.

In some implementations, one of the different coded PDU segments is retransmitted on a condition that the WTRU receives a retransmission grant for a HARQ PID associated with the one of the plurality of different transmission occasions. In some implementations, the plurality of different transmission occasions comprises a number of different transmission occasions, wherein the number is received in a dynamic indication. In some implementations, a dynamic indication is received which indicates whether segmentation is used, a number of slots on which the coded PDU segments are transmitted, whether the mapping comprises interleaving, whether the mapping comprises frequency hopping, and/or the HARQ PIDs of the associated HARQ processes.

In some implementations, each of the plurality of different transmission occasions comprises a slot. In some implementations, modulated symbols of each coded PDU segment are mapped to a different slot. In some implementations, the plurality of coded PDU segments are encoded after the MAC PDU is split into the plurality of different coded PDU segments. In some implementations, the MAC PDU is encoded before it is split into the plurality of different coded PDU segments. In some implementations, a different MAC PDU is transmitted using scheduled HARQ processes not associated with the plurality of different coded PDU segments. In some implementations the transmission occasion is a physical uplink shared channel (PUSCH) transmission occasion. In some implementations the transmission occasion is a physical uplink control channel (PUCCH) transmission occasion. In some implementations a timer is maintained for each of the different HARQ PIDs, wherein the WTRU stops and/or starts the time for each of the different HARQ PIDs simultaneously.

Some implementations provide a wireless transmit receive unit (WTRU), a network device configured for wireless networking, computing device, integrated circuit, eNodeB (eNB), next generation node-B (gNB), base station (BS), or access point (AP) configured to perform a method as described above. Some implementations provide A non-transitory computer readable medium including instructions which when executed by a processing device cause the processing device to perform a method as described above.

Various abbreviations and acronyms used herein include the following: Configured grant or cell group (CG) depending on context; Dynamic grant (DG); Channel access priority class (CAPC); Downlink feedback information (DFI); HARQ Process ID (HARQ PID); enhanced Licensed Assisted Access (eLAA); Further enhanced Licensed Assisted Access (FeLAA); MAC control element (MAC CE); RACH occasion (RO); random access (RA); physical random-access channel (PRACH); Acknowledgement (ACK); Block Error Rate (BLER); Bandwidth Part (BWP); Channel Access Priority (CAP); Clear Channel Assessment (CCA); Cyclic Prefix (CP); Conventional OFDM relying on cyclic prefix (CP-OFDM); Channel Quality Indicator (CQI); Cyclic Redundancy Check (CRC); Channel State Information (CSI); Contention Window (CW); Contention Window Size (CWS); Channel Occupancy (CO); Downlink Assignment Index (DAI); Downlink Control Information (DCI); Downlink (DL); Demodulation Reference Signal (DM-RS); Data Radio Bearer (DRB); Hybrid Automatic Repeat Request (HARQ); License Assisted Access (LAA); Listen-Before-Talk (LBT); Long Term Evolution, e.g., 3GPP LTE R8 and up, (LTE); Negative ACK (NACK); Modulation and Coding Scheme (MCS); Multiple Input Multiple Output (MIMO); New Radio (NR); Orthogonal Frequency-Division Multiplexing (OFDM); Physical Layer (PHY); Physical Random Access Channel (PRACH); Primary Synchronization Signal (PSS); Random Access Channel (or procedure) (RACH); Random Access Response (RAR); Radio access network Central Unit (RCU); Radio Front end (RF); Radio Link Failure (RLF); Radio Link Monitoring (RLM); Radio Network Identifier (RNTI); Radio Resource Control (RRC); Radio Resource Management (RRM); Reference Signal (RS); Reference Signal Received Power (RSRP); Received Signal Strength Indicator (RSSI); Service Data Unit (SDU); Sounding Reference Signal (SRS); Synchronization Signal (SS); Secondary Synchronization Signal (SSS); Switching Gap, in a self-contained subframe, (SWG); Semi-persistent scheduling (SPS); Supplemental Uplink (SUL); Transport Block (TB); Transport Block Size (TBS); Transmission/Reception Point (TRP);Time-sensitive communications (TSC); Time-sensitive networking (TSN); Uplink (UL); Ultra-Reliable and Low Latency Communications (URLLC); Wide Bandwidth Part (WBWP); Wireless Local Area Networks and related technologies, e.g., in the IEEE 802.xx domain, (WLAN).

Some NR implementations include multi-TTI scheduling. In some NR Release 15 implementations, uplink slot aggregation is supported, e.g., whereby a WTRU can transmit the same transport block (TB) on multiple consecutive slots, possibly with different redundancy versions (RV) and frequency hopping. This may be supported for both dynamic and configured grants. A grant for the same TB may be repeated across up to eight slots using the same HARQ Process. Each repetition within a bundle of repetitions may be treated like a retransmission with RV incremented without waiting for feedback. For example, in some implementations, 8 consecutive transmissions of the same TB with different RVs are similar to 8 retransmissions with RV incremented but without waiting for HARQ feedback.

In some NR Release 16 implementations, multi-TTI scheduling is enhanced, e.g., for NR-U WTRUs. In some examples, a gNB may allocate multiple physical uplink shared channel (PUSCH) transmission occasions to a WTRU using a single DCI; e.g., to reduce the number of LBTs and/or increase the chance of channel acquisition. PUSCH occasions of a multi-TTI grant may be continuous in the time domain. A single DCI scheduling a multi-TTI grant may indicate a HARQ process ID, number of occasions, and/or RV. The signaled HARQ PID may apply to the first TTI/PUSCH occasion in the bundle. For each later or subsequent PUSCH occasion, the WTRU may increment the signaled PID by 1. The WTRU may map a generated TB to different HARQ processes if LBT fails, and the WTRU may transmit a TB pending transmission in a HARQ process due to a failed LBT in a different HARQ process associated with a PUSCH for which LBT was successful. The TB may include or be a different and/or new TB if the same RV and TB size (TBS) as signaled is used.

Some implementations include code-domain coverage enhancements in a physical uplink control channel (PUCCH). In some implementations, e.g., for NR-PUCCH, multiple formats are possible for a given PRB. For example, with format 0 (short PUCCH), 1 or 2 symbols may be used to transmit up to 2 bits of UCI (e.g., including HARQ-ACK or SR). The two bits may be the same in each symbol. In some implementations, a different cyclic shift may be used in the second symbol, resulting in frequency diversity. With format 2 (short PUCCH), for example, 1 or 2 symbols may be used to transmit more than 2 bits of UCI (e.g., including CSI reports, multi-bit HARQ-ACK codebooks, and/or SR). With format 1 (long PUCCH), for example, a maximum of 2 bits can be transmitted, as half of the symbols are for RS channel estimation. In some implementations, it is possible to configure frequency hopping (as in LTE). With format 3 or format 4 (long PUCCH), more than 2 bits can be transmitted, possibly with frequency hopping and UE code-multiplexing.

In some implementations, PUCCH may be configured on a Primary Cell (PCell) and a Primary Secondary Cell (PSCell). A WTRU may be configured with two PUCCH groups, where each group may be used to provide UCI for a number of DL carriers.

In some implementations, NR-PUCCH bits may be coded with orthogonal codes to provide better (e.g., relative to uncoded NR-PUCCH bits) PUCCH capacity, possibly while maintaining good (e.g., better than short PUCCH) coverage for the longer PUCCH formats.

To generate such orthogonal codes, a sequence of base length of 12 may be used (e.g., the same sequence used for RS generation). This may result in 12 possible cyclic shifts in the time domain (i.e., 12 phase rotations in frequency domain), and thus it may be possible to multiplex up to 12 WTRUs; e.g., if they each transmit 1 bit on the same resource and use the same MCS. In some implementations, not all cyclic shifts may be usable; e.g. in high delay spread and/or multipath environments, or during symbols that occupy RS.

For long PUCCH formats, additional spreading may be performed using orthogonal discrete Fourier transform (DFT) codes, e.g., to match the number of symbols of the long PUCCH format. In some implementations, this may additionally or alternatively increase WTRU multiplexing capacity while improving coverage (e.g., for devices with the same cyclic shift). In some implementations, the number of devices that can be multiplexed on the same resource can be roughly estimated as the length of the orthogonal code + number of cyclic shifts used.

In some implementations, cyclic shift hopping is applied for PUCCH transmissions. In some implementations, cyclic shift may be varied between different slots by adding an offset each slot, whereby the offset is given by a WTRU pseudo-random sequence. In some implementations, this randomizes interference between different WTRUs and/or different cells. In some implementations, if the number of PUCCH bits is large (e.g., larger than 2 bits), a scrambling sequence based on C-RNTI may be used to randomize interference between WTRUs and other cells. A maximum code rate may be used to determine resource consumption.

Some implementations include a HARQ operating point. From the network’s perspective, a scheduler may operate using a target HARQ operating point. The number of HARQ transmissions required for successful reception and decoding of a transport block; e.g., to reach a sufficient amount of received energy per transmitted bit, may be referred to as a HARQ operating point. In some implementations, a scheduler may vary the HARQ operating point to optimize resource usage (e.g., number of PRBs for the transmission of a given TB), transmission power (e.g., more transmissions each of less power, or vice-versa) and/or latency (e.g., fewer transmissions, which may complete the transmission earlier in time). In some implementations a scheduler may adapt a HARQ operating point, e.g., by varying the number of PRBs, the assigned MCS and/or the transmission power, e.g., to implement different strategies for the accumulation of transmitted energy at the receiver.

Some implementations include block coding. Repetition of data can be considered to be a simple repetition coding. In some implementations, if more than 2 resource sets are available, instead of replicating the same data for all transmissions, a block coding stage may be introduced, e.g., where the data (either raw data bits or modulated bits) is first split into a K blocks from which K+L MAC-coded blocks are generated and transmitted over K+L resource sets. At the receiver side, the data may be recovered if at least K transmissions are successfully received. In an example, for the case of 3 resource sets, the data may be split into 2 blocks and an additional block may be generated as the sum (e.g., binary sum) of the 2 blocks (e.g., as a parity code). In cases including more resource sets, codes such as Reed-Solomon or fountain codes may be used to generate the additional blocks. In some implementations, each MAC-coded block may be sent to the physical layer as a separate TB or a TB segment.

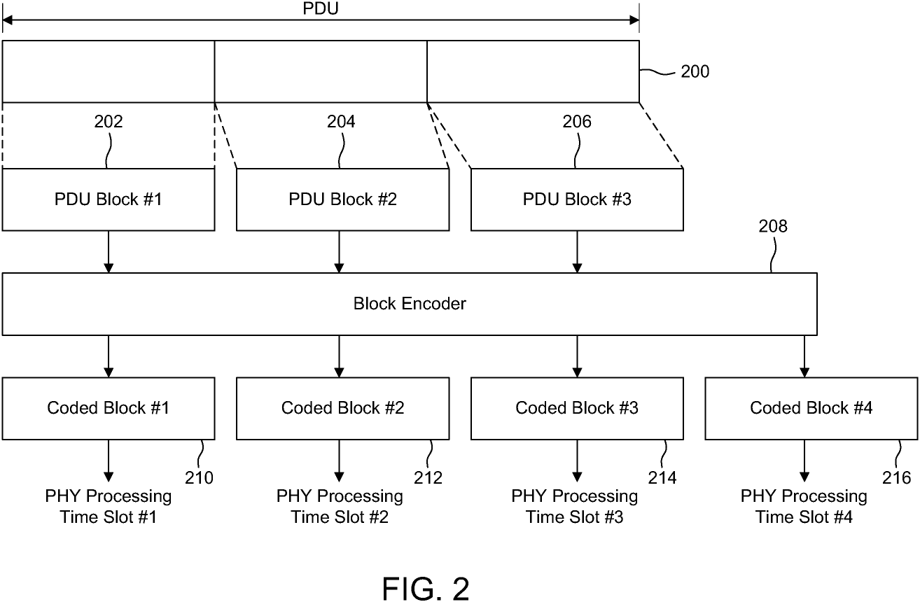

FIG. 2 is a block diagram which illustrates an example block coding scheme for 4 resource sets (K=3, L=1) in time domain. In FIG. 2, a PDU 200 is divided into three PDU blocks 202, 204, 206. Block encoder 208 encodes PDU blocks 202, 204, 206 as coded blocks 210, 212, 214, 216. In this example, PDU blocks 202, 204, 206 are encoded as coded blocks 210, 212, and 214 respectively, and coded block 216 is generated as the sum of coded blocks 210, 212, and 214 (e.g., as a parity code) Coded blocks 210, 212, 214, 216 are sent to physical layer processing for transmission during different time slots. It is noted that sum refers to the binary sum of the 3 blocks as used with respect to this figure. For example, if coded block 210 = (a1, a2, ..., aN), coded block 212= (b1, b2, ..., bN) and coded block 214= (c1, c2, ..., cN), then coded block 216= (a1+b1+c1, a2+b2+c2, ..., aN+bN+cN), where + is the binary sum.

In some implementations, such block coding may be more efficient under conditions with larger numbers of resource sets and sparse fading (e.g., fast fading) and/or bursty interference, e.g., due to the probability of deep fading hitting an undesirable number (e.g., above a threshold number, or more than a few) resource sets is very low. In some implementations, for N resource sets, block coding consumes only an (N/K)-fold increase (e.g., approximately) of energy per information bit for transmission, with N = K+L.

In some implementations, channel state information (CSI) may include at least one of the following: channel quality index (CQI), rank indicator (RI), precoding matrix index (PMI), a layer 1 (L1) channel measurement (e.g., RSRP such as L1-RSRP, or signal to interference plus noise ratio (SINR)), CSI-RS resource indicator (CRI), SS/PBCH block resource indicator (SSBRI), layer indicator (LI) and/or any other measurement quantity measured by the WTRU from the configured CSI-RS or SS/PBCH block.

In some implementations, uplink control information (UCI) may include: CSI, HARQ feedback for one or more HARQ processes, a scheduling request (SR), a link recovery request (LRR), CG-UCI and/or other control information bits. In some implementations, the UCI may be transmitted on the PUCCH or PUSCH. In some implementations, channel conditions may include any conditions relating to the state of the radio/channel, which may be determined by the WTRU based on a WTRU measurement (e.g., L1/SINR/RSRP, CQI/MCS, channel occupancy, RSSI, power headroom, exposure headroom), L3/mobility-based measurements (e.g., RSRP, RSRQ), an RLM state, and/or channel availability in unlicensed spectrum (e.g., whether the channel is occupied based on determination of an LBT procedure or whether the channel is deemed to have experienced a consistent LBT failure).

In some implementations, a PRACH resource includes a PRACH resource (e.g., in frequency), a PRACH occasion (RO) (e.g., in time), a preamble format (e.g., in terms of total preamble duration, sequence length, guard time duration and/or in terms of length of cyclic prefix) and/or a certain preamble sequence used for the transmission of a preamble in a random access procedure.

In some implementations, a property of scheduling information (e.g., of an uplink grant or a downlink assignment) may include at least one of: a frequency allocation; an aspect of time allocation (e.g., a duration; a priority; a modulation and coding scheme; a transport block size; a number of spatial layers; a number of transport blocks to be carried; a TCI state or SRI; a number of repetitions; whether the grant is a configured grant type 1, type 2 or a dynamic grant; whether the repetition scheme is Type A or Type B; whether the grant is a configured grant type 1, type 2 or a dynamic grant; a configured grant index or a semi-persistent assignment index; a periodicity of a configured grant or assignment; a channel access priority class (CAPC); and/or any parameter provided in a DCI, by MAC-CE or by RRC signaling for the scheduling the grant or assignment.

In the following, a property of the data included in a transport block (TB) may refer to a parameter configuring a logical channel or radio bearer for which data may be included in the TB. For example, a property of the data included in a TB may include at least one of a logical channel priority, prioritized bit rate, logical channel group, and/or RLC mode. By extension, a property of a grant or assignment may also refer to a property of the data included in the corresponding TB.

In some implementations, an indication by a DCI may include at least one of: an explicit indication by a DCI field or by RNTI used to mask CRC of the PDCCH, and/or an implicit indication by a property such as DCI format, DCI size, coreset or search space, aggregation level, and/or identity of first control channel resource (e.g., index of first CCE) for a DCI, where the mapping between the property and the value may be signaled by a RRC signaling or MAC-CE.

In low SNR conditions, transmission based on repetitions with RV cycling may not be optimal; e.g., in situations where power headroom is limited, cell capacity is limited, or where latency requirements are stringent. Coverage enhancement repetition techniques may require a non-narrowband frequency domain allocation to accommodate the TB size within a slot (e.g., potentially more than 1 PRB).

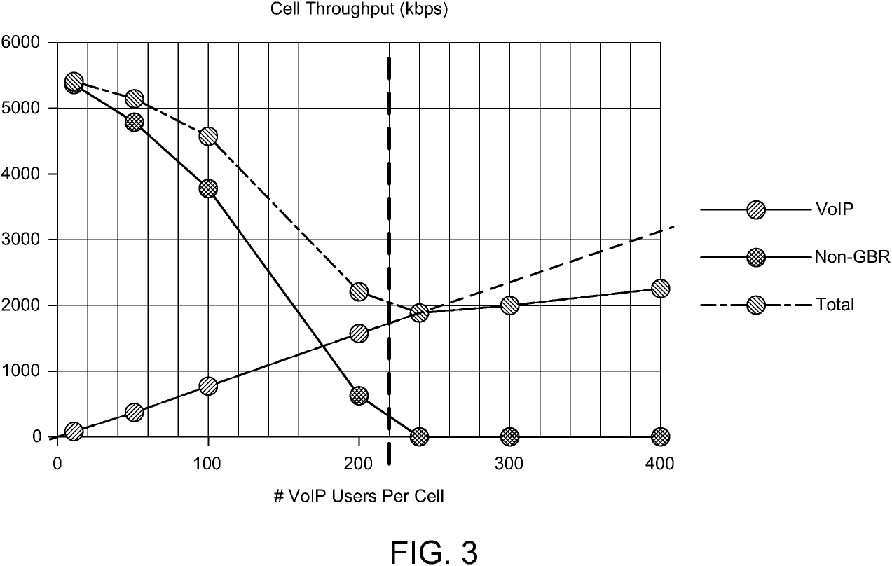

Even if the TB size is not be large, there may be certain latency requirements (e.g., for VoIP or TSC traffic) which may not be met if numerous repetitions are necessary to meet the HARQ operating point. Further, from a cell load/capacity point of view, if the cell is serving many devices in cell-edge conditions, repetition may limit the number of served devices and may yield to starvation of non-GBR traffic in the cell. This is illustrated in FIG. 3.

FIG. 3 is a graph reflecting cell throughput for different numbers of VoIP users per cell for a simulation of a cell supporting VoIP and internet traffic in an LTE cell at 10 Megahertz. In an example, for a VOIP service, packets arrive in 308 kbps bursts every 20 ms, which corresponds to 15.4 kbps. The maximum data rate can thus be 15.4 kbps, which includes header overhead and robust header compression (ROHC). The ROHC, packet data convergence protocol (PDCP), radio link control (RLC), and/or medium access control MAC headers may be dropped if the grant size cannot accommodate it. The guaranteed bit rate is thus 12.2 kbps, which accommodates the data bits without headers. As illustrated in FIG. 3, the network can serve up to 240 VoIP users with 15.4 kbps, though the internet best effort rate drops with the addition of more VoIP users. With more than 240 VoIP users, non-GBR traffic is halted and additional VoIP users are served with 12.2 kbps bits. This illustrates that supporting many VoIP users in a single cell can be capacity limited, especially when coverage requires repetitions.

Thus, in some implementations, relying solely on repetitions to meet coverage requirements for GBR traffic can come with one or more of the following costs and shortcomings: a non-narrow band frequency allocation, thus reducing the TB’s power spectral density; an increase of latency required to transmit the TB/reach the required HARQ operating point; and/or increased cell load, which may come at the cost of other service types/users in the cell.

In some implementations, spreading the TB over multiple slots in the time domain may improve the power spectral density. In some implementations, a single TB can be scheduled over multiple slots with a narrow frequency allocation, or the TB can be split into multiple coded segments that are transmitted over multiple TTIs. It may be desired to retransmit a portion of the TB that was not successfully decoded. Given the TBS is small, CBG retransmission may not be possible.

In some implementations, depending on the selected solution, one TB may be associated with more than one HARQ Process. In some such cases, HARQ process buffer management and/or flushing the buffer upon new data indicator (NDI) toggling may be complicated. For example, timers and operations maintained at higher layers (e.g., discontinuous reception (DRX) timers, retransmission grants and timers, CG timers etc.) are maintained per HARQ Process and are based on having a 1-to-1 mapping between a TB and HARQ process.

A “slot” may refer to a set of 14 time symbols, e.g., as defined in NR specifications. A “sub-slot” may refer to a smaller set of time symbols within a slot, or possibly across two slots. The terms “slot” and “sub-slot” may be used interchangeably, and solutions applicable to the level of a slot may also be applicable to the level of sub-slot. A time interval for which resources are available for the WTRU to map PUSCH modulation symbols and associated DMRS of a PUSCH transmission may be referred to as a “PUSCH occasion”. A time interval for which resources are available for the WTRU to map PUCCH modulation symbols and associated DMRS of a PUCCH transmission may be referred to as a “PUCCH occasion”.

Some implementations combine resources of multiple slots for a single PUSCH (or PUCCH) occasion for multi-slot transmission. In some implementations, the WTRU may generate a transmission that occupies resources spanning more than one slot (M slots) in the time domain. Such processing may be referred to as “multi-slot transmission”. Such processing may be applicable to PUSCH and/or PUCCH transmissions. In some implementations, such processing may be applicable to other kinds of transmissions.

If a WTRU performs a multi-slot transmission, modulated symbols for the transmission may be mapped to the combined resources of the multiple slots. For example, the modulated symbols may be mapped in the same way as in existing systems (e.g., frequency first, time second). In some implementations, the physical resources for a multi-slot transmission may include a set of M slots. In some implementations, the physical resources for a multi-slot transmission may also include at least one of the following for each slot: time symbols; frequency-domain allocation (set of PRB’s), including frequency hopping information; spreading codes; beam indication such as SRS identifier, CSI-RS identifier or TCI state; bandwidth part; subcarrier spacing; DMRS configuration or mapping type; and/or a resource index (e.g. for PUCCH).

In some implementations, the WTRU may determine whether to perform multi-slot transmission, the number of slots M, and/or at least one property of a grant, from an explicit indication by DCI or from a semi-static configuration. The WTRU may obtain at least one of the time symbols; frequency-domain allocation (set of PRB’s), including frequency hopping information; spreading codes; beam indication such as SRS identifier, CSI-RS identifier or TCI state; bandwidth part; subcarrier spacing; DMRS configuration or mapping type; and/or a resource index (e.g. for PUCCH) and apply it to all slots. The WTRU may obtain at least one of the time symbols; frequency-domain allocation (set of PRB’s), including frequency hopping information; spreading codes; beam indication such as SRS identifier, CSI-RS identifier or TCI state; bandwidth part; subcarrier spacing; DMRS configuration or mapping type; and/or a resource index (e.g. for PUCCH) separately for each slot. Multi-slot transmission may be applicable to a subset of HARQ processes configured by higher layers.

In some implementations, the WTRU may determine the set of M slots based on at least one of: a higher-layer configuration; a timing (e.g. slot index) of the DCI indicating the transmissions; a delay between DCI reception and start of transmission (e.g., indicated by a time-domain resource allocation field); a number of slots configured by higher layers or indicated by DCI; and/or a slot configuration for at least one slot, configured by higher layers and/or indicated by DCI (e.g., in a slot formation indication).

For example, the WTRU may determine the set of slots as a set of K slots starting from the slot index in which DCI is received (n) plus a delay in terms of slots (k2). The set of slots may be a set of K consecutive slots {n+k2, n+k2+1, ... n+K-1} or a set of the first K slots following and including slot n+k2 that correspond to certain slot configurations configured semi-statically and/or indicated dynamically. For example, the set of slots may correspond to slot configurations comprising only uplink symbols or slot configurations comprising at least one uplink symbol.

Alternatively, the WTRU may determine the resource in time domain as a set of N time symbols following and including symbol m+k2 where m may be the symbol index of the last (or first) symbol of the PDCCH containing the grant, and k2 may correspond to a delay in number of symbols. The set of N time symbols may correspond to symbols that are configured as uplink, or possibly configured as uplink or flexible, as per the slot configuration.

In some implementations, the WTRU may multiply the modulated symbols (or the coded bits) by a spreading sequence in time domain prior to mapping to physical resources. The size of the spreading sequence may be a function of (or correspond to) the number of slots M of the multi-slot allocation and/or the number of resource elements available for transmission. Such spreading operation may facilitate multiplexing of WTRUs in the same resource.

Some implementations include transmission or retransmission of segments of a multi-slot transmission. In some implementations, a WTRU may process a TB and map modulated symbols over the resources of a set of slots, e.g., as described above. In some implementations, the WTRU may determine a set of coded bits and/or modulated symbols for transmission over each slot (or sub-slot). Each such set of coded bits and/or modulated symbols mapped to the resources of a slot (or sub-slot) may be referred to as a segment of the multi-slot transmission.

In some implementations, the WTRU may transmit a first segment of a transmission over a first slot or set of slots and later retransmit the segment over a second slot or set of slots. In some implementations, the WTRU remaps the coded bits and/or modulated symbols of the segment to the resources of the second slot or set of slots for the retransmission. To support this, in some implementations, the WTRU may keep the coded bits and/or modulated symbols for each applicable HARQ process in memory, and may flush this information when new data is indicated for the HARQ process.

In some implementations, the WTRU may transmit or retransmit a segment in a slot, based on a higher layer configuration and/or a dynamic indication. For example, the WTRU may receive a DCI indicating a multi-slot transmission of M slots for a TB of a HARQ process. The DCI may also indicate a subset of segments for mapping over M′<=M slots, where the M′ slots may be determined using one of the above-described methods for multi-slot or multi-PUSCH transmission. For example, in some implementations, the indication of the subset of segments may include a bitmap, and M′ may indicate the number of segments to be transmitted or retransmitted according to the bitmap.

In some implementations, the WTRU may transmit a TB over multiple slots, where the slots, or sets of slots, may or may not be consecutive.. For example, the WTRU may transmit the TB over a first set of slots, and later transmit or retransmit another segment of the TB over a second set of slots. The WTRU may transmit or retransmit the other segment of the TB over the second set of slots, e.g., upon or after an interruption of the transmission of the first segment. The transmission of the second segment may be triggered by a condition, event or signal. For example, the transmission of the second segment may be triggered by scheduling a grant, or by the availability of a grant, for the second set of slots. The second set of slots may be non-consecutive in the time domain with the first set of slots. The WTRU may determine which part of the TB to transmit or retransmit; e.g., based on the number of slots, number of PRBs, TBS, and/or resource allocation of the grant on the second set of slots. For example, The WTRU may transmit part of a TB that was dropped (i.e., not transmitted for a specific reason). For example, the WTRU may transmit part of the TB that was dropped due to UL slot cancellation or due to UL slot unavailability (e.g., in a dynamic time domain duplex (TDD) environment) in the grant on the second set of slots. In some implementations, the WTRU may transmit the part of the TB that was dropped due to UL slot cancellation or UL slot unavailability if the second grant matches the number of slots interrupted in the first set of slots or has a grant size larger than the size (e.g., in bits or REs) of the UL slot that was cancelled or interrupted. The WTRU may transmit such transmission or retransmission of the TB segment subject to a condition. For example, the WTRU may transmit or retransmit the TB if a grant is received for the second set of slots, if the grant is for the same HARQ process used to transmit/store the TB initially, if the grant is a retransmission grant (e.g., indicated by the NDI not being flipped), if the size of the grant is greater than or equal to the size of the interrupted/indicated slots (e.g., the grant is scheduled over the same number of slots and/or PRBs of interrupted slots), and/or if the TBS of the grant is less than or equal to the size of the TB.

In some implementations, the WTRU may retransmit one or more PUSCH transmissions in a multi-slot transmission, in one or more slots, if the PUSCH transmissions are pre-empted. For example, the PUSCH transmissions may have been pre-empted by other PUSCH transmissions, by PUCCH transmissions, or by other reference signals. The WTRU may receive a configuration from the network to retransmit a pre-empted PUSCH transmission or transmissions in one or more slots scheduled by DCI. In some implementations, the WTRU may transmit or retransmit a PUSCH transmission (e.g., a TB or part of the TB) on a second retransmission grant scheduled for a second set of slots. In some implementations, the WTRU may transmit or retransmit the PUSCH transmission on a second retransmission grant scheduled for a second set of slots if the number of slots and/or PRBs of the second grant match the number of slots and/or PRBs cancelled or pre-empted during the initial transmission or retransmission.

Some implementations include multi-PUSCH transmission. In some implementations, the WTRU may generate a set of PUSCH transmissions processed from (e.g., based on multiple coded blocks from) the same transport block (TB), and may transmit each PUSCH transmission of the set in a different PUSCH occasion. PUSCH repetition schemes defined in existing systems are examples of multi-PUSCH transmissions, where a PUSCH occasion corresponds to a set of symbols within a slot, and the set of PUSCH transmissions are generated from different redundancy versions of the channel-coded bits.

Some implementations include multi-PUCCH transmission. In some implementations, the WTRU may generate a set of PUCCH transmissions processed from (e.g., based on multiple coded blocks from) the same uplink control information (UCI) bits, and may transmit each PUCCH transmission of the set in a different PUCCH occasion. PUCCH repetition schemes defined in existing systems are examples of multi-PUCCH transmissions, where a PUCCH occasion corresponds to a set of symbols within a slot, and the set of PUCCH transmissions are repetitions.

Some implementations include combined multi-PUSCH (or multi-PUCCH) and multi-slot operation. In some implementations, the WTRU may generate a set of PUSCH (or PUCCH) transmissions, and may transmit each PUSCH (or PUCCH) during either a single-slot or multi-slot PUSCH (or PUCCH) occasion. The WTRU may determine the number of transmissions K, and may determine parameters defining a multi-slot allocation as per the above for each transmission; and/or the above parameters may be configured by RRC or signaled by DCI. The WTRU may also determine a set of slots Sk associated with each transmission k, and may assign the resources indicated for the set of slots Sk for the kth repetition. Such determination may be implicit from a number of slots per multi-slot allocation M or from a total number of slots over all repetitions Mt obtained by semi-static or dynamic signaling.

Some implementations include transmission of coded TB segments over multiple PUSCH occasions. Various examples that follow illustrate an example multi-PUSCH transmission scheme. Some implementations enable TB transmission over one or more slots. For example, in some implementations, an information element is used to configure a time domain relation between PDCCH (carrying a DCI scheduling UL grant) and PUSCH, and the time domain length of the scheduled PUSCH. In some implementations, the information element is a “PUSCH time domain resource allocation” and/or “PUSCH-Allocation-r16” information element. In some implementations, the information element (e.g., “PUSCH time domain resource allocation” information element) includes a K2 value, a mapping type, and/or a start symbol and length (SLIV). In some implementations, the K2 value indicates a time difference between PUCCH and PUSCH in units of slots. In some implementations, the mapping type indicates a mapping type of DMRS within the allocated resources. In some implementations, the start symbol and length (SLIV) indicates a PUSCH start symbol and length in units of symbols.

As used herein, a “list of possible PUSCH time domain resource allocations” may include a PUSCH-TimeDomainResourceAllocationList or puschAllocationList-r16 information element, e.g., as used in 3GPP specifications.

Some implementations dynamically enable multi-slot PUSCH transmissions. In some implementations, a WTRU may be configured to interpret the length indicated by the SLIV parameter of the information element (e.g., of a “PUSCH time domain resource allocation”, “PUSCH-TimeDomainResourceAllocationList” and/or “PUSCH-Allocation-r16” information element) in units of slot instead of symbols. For example, an information element (e.g., “PUSCH time domain resource allocation”, or “PUSCH-TimeDomainResourceAllocationList” information element) may include a parameter (e.g., an additional parameter) that indicates the unit of the PUSCH time domain resource allocation. Alternatively, in some implementations the SLIV parameter is replaced by a starting symbol parameter and/or an additional parameter to indicate the number of allocated slots for multi-slot transmission.

In some implementations, a WTRU may be configured semi-statically (e.g., using RRC signaling) with a list of possible PUSCH time domain resource allocations. In some implementations, the list of possible PUSCH time domain resource allocations includes a sub-set of PUSCH time domain resource allocations over multiple slots. In some implementations, the list of possible PUSCH time domain resource allocations also or alternatively includes a sub-set of PUSCH time domain resource allocations over a single slot and/or sub-slot. In some implementations, a DCI scheduling an uplink grant may include an indication (e.g., a bit field) indicating a PUSCH time domain resource allocation to use, from the configured list. In some implementations, after receiving the uplink grant, the WTRU determines whether the PUSCH transmission is over multiple slots or over a single slot or sub-slot using the time domain resource allocation indication.

In some implementations, a WTRU may be configured semi-statically(e.g., using RRC signaling) with two separate lists of possible PUSCH time domain resource allocations. In some implementations, the first list includes only PUSCH time domain resource allocations over multiple slots. In some implementations, the second list includes only PUSCH time domain resource allocations over a single slot or sub-slot. In some implementations, a DCI scheduling an uplink grant may include an indication (e.g., a bit field) indicating which list to select from. In some implementations, the DCI scheduling the uplink grant may include an indication (e.g., a bit field) indicating which PUSCH time domain resource allocation to use, from the indicated list. In some implementations, after receiving the uplink grant, the WTRU determines whether the PUSCH transmission is over multiple slots or over a single slot or sub slot, based on the bit field indication that indicates which list to select from.

In some implementations, a WTRU may be configured semi-statically (e.g., using RRC signaling) with a list of possible PUSCH time domain resource allocations that includes only PUSCH time domain resource allocations over a single slot and/or sub-slot. In some implementations, a DCI scheduling an uplink grant may include an indication (e.g., a bit field) indicating a number of allocated slots, which are in addition to the time domain resource allocations over the single slot and/or sub-slot. In some implementations, a WTRU may determine that the scheduled grant is a transmission over multiple slots if the indicated number of allocated slots is greater than 1. In some implementations, the WTRU may assume that the indicated SLIV is the same across different scheduled slots. In some implementations, alternatively, the WTRU may assume that the SLIV is in units of slots instead of symbols if the number of allocated slots is above 1.

Some implementations include retransmission using a single slot. For example, in some implementations, a WTRU may be configured to retransmit a transport block, initially transmitted on a multi-slot PUSCH transmission, using a single slot PUSCH transmission. In some implementations, a WTRU may determine the type of PUSCH transmission (e.g., a single slot PUSCH transmission or multi-slot PUSCH transmission) e.g., using methods described herein. In some implementations, if the WTRU uses a single slot for retransmission, the WTRU may be configured to use a modulation and coding scheme (MCS) index that is higher than a preconfigured MCS value.

Some implementations include non-contiguous and/or interrupted multi-slot transmission. For example, in some implementations, a WTRU may be configured to transmit a non-contiguous multi-slot PUSCH transmission. In some implementations, the slots and/or symbols available for the non-contiguous multi-slot PUSCH transmission may be indicated using an indication (e.g., a dedicated bit field) in the DCI. In some implementations, the slots and/or symbols available for the non-contiguous multi-slot PUSCH transmission may be indicated by re-using existing fields (e.g., existing bit fields, such as the FDRA and/or MCS bit fields) in the DCI. In some implementations, a WTRU may be configured to transmit a multi-slot PUSCH transmission and to receive an indication that part of the configured slot, slots, symbol, or symbols for transmission are not available. This indication may be referred to as an interruption indication. In some implementations, the WTRU stops transmitting in the slot, slots, symbol, or symbols indicated by the interruption indication. In some implementations, the interruption indication may be transmitted in a different DCI than the scheduling DCI. For example, after receiving the UL grant and starting transmitting, the WTRU may receive another DCI indicating that a set of resources (slots and/or symbols) are not available and that the WTRU should stop transmitting on the indicated resources. In some implementations, the interruption indication may be transmitted in the scheduling DCI.

In some implementations, a WTRU may exclude and/or not transmit on the resources of configured or preconfigured uplink signals and/or channels overlapping with a scheduled multi-slot PUSCH transmission. In some implementations, the pre-configured signals and/or channels may include a PUSCH, PUCCH, or PRACH transmission, an SRS, or a SR. For example, in some implementations, a WTRU is semi-statically configured with a configured grant (CG) PUSCH transmission. The WTRU may receive a multi-slot PUSCH grant from the gNB that overlaps partially or completely with the CG PUSCH transmission. The WTRU may prioritize the transmission of the multi-slot PUSCH transmission and may drop (i.e., stop or not transmit) the CG PUSCH transmission (e.g., the whole transmission or just in the overlapping resources). In some implementations, alternatively, the WTRU may be configured to prioritize the configured transmission and to stop and/or not transmit the multi-slot PUSCH transmission (e.g., the whole transmission or just in the overlapping resources). In some implementations, the WTRU may determine whether to prioritize the transmission of the multi-slot PUSCH or to prioritize the configured uplink transmission. In some implementations, the WTRU may make this determination based on an explicit indication in the DCI.

Some implementations include re-using existing bit fields in the DCI to indicate a multi-slot PUSCH parameter or parameters. For example, in some implementations, a WTRU may be configured to receive parameters related to multi-slot PUSCH transmission in an existing bit field or bit fields of the DCI. In some implementations, a WTRU may be configured to receive the multi-slot PUSCH parameter or parameters using one or more of the following bit fields, or portions thereof: the Frequency Domain Resource Allocation (FDRA) field; the Modulation and Coding Scheme (MCS) field; and/or the Bandwidth part indicator field.

In some implementations, the multi-slot PUSCH parameter or parameters may indicate or include, for example, one or more of the following: the number of scheduled slots for multi-slot PUSCH; the list of possible PUSCH time domain resource allocations for multi-slot PUSCH (e.g., as described herein); the slots available for the multi-slot PUSCH transmission (e.g., as described herein); the interruption indication within the set of allocated slots (e.g., as described herein); and/or parameters related to groups of coded bits (e.g., as described herein).

In some implementations, a WTRU may determine whether multi-slot PUSCH transmission parameters are carried in the existing bit fields and/or whether multi-slot PUSCH transmission is enabled based on one or more (e.g., a combination) of the following: the RNTI used to schedule the uplink grant; a value of one of one of the existing bit fields; the search space set on which the scheduling DCI is received; the CORESET on which the scheduling DCI is received; the bandwidth part on which the DCI is received; the bandwidth part on which the PUSCH is scheduled; the component carrier (CC) on which the DCI is received; and/or the CC on which the PUSCH is scheduled.

For example, in some implementations, the WTRU determines whether multi-slot PUSCH transmission parameters are carried and/or whether multi-slot PUSCH transmission is enabled based on the RNTI used to schedule the uplink grant, where a new RNTI is introduced for multi-slot scheduling.

In another example, in some implementations, the WTRU determines whether multi-slot PUSCH transmission parameters are carried and/or whether multi-slot PUSCH transmission is enabled based on the value of one of one of the existing bit fields. For example, a value of a time domain resource allocation field may trigger the WTRU to limit the set of possible frequency domain allocations and/or Modulation Coding Scheme fields. In some implementations, a WTRU is configured with a FDRA/MCS bitfield with N, M sizes respectively. If the WTRU receives a multi-slot PUSCH grant indicated by TDRA, the WTRU may determine the frequency allocation resources using N1<N bits in the FDRA bitfield and the MCS using M1<M bits. In some implementations, the remaining N-N1 bits and M-M1 bits may carry multi-slot PUSCH transmission parameters.

Some implementations involve power allocation. For example, in some implementations, a WTRU may receive an implicit and/or explicit indication to maintain power and/or phase continuity between different slots if multi-slot PUSCH transmission is used. In some implementations, the DCI scheduling the multi-slot PUSCH transmission may indicate or include the power configuration for different slots. In some implementations, a transmit power control command or phase control command may include an indication to use the same spatial filter and/or precoding scheme across different slots in a multi-slot PUSCH transmission.

Some implementations involve multiplexing with other signals and/or channels. For example, in some implementations, a WTRU may determine to multiplex other signals or channels with the PUSCH in a multi-slot transmission. In some implementations, the WTRU may determine to multiplex the PUSCH in the multi-slot transmission with another reference signal or signals, such as SRS, DMRS or PTRS, or PUCCH based on one or more conditions or combinations of conditions. In some implementations, the WTRU may determine to multiplex the PUSCH in the multi-slot transmission with the other reference signal or signals based on at least one of the following conditions: the number of resource blocks allocated for the multi-slot transmission; the number of slots allocated for the multi-slot transmission; and/or the number of symbols allocated for each slot or all slots in the multi-slot transmission. For example, in a case where a WTRU is configured semi-statically with a PUCCH resource to be used for HARQ ACK/NACK, if the WTRU is scheduled for a multi-slot PUSCH transmission that overlaps with a PUCCH transmission, the WTRU may determine whether it can transmit multiple PUCCH on PUSCH (e.g., piggybacking in multi-slot PUSCH) transmissions based on the scheduled resource blocks for multi-slot PUSCH/number of slots for PUSCH. Instead of transmitting multiple PUCCH, multi-slot PUSCH can carry multiple UCI “piggybacked” in the multi-slot PUSCH. For example, if multi-slot PUSCH is scheduled in slot 0, 1, 2 and 3, and two PUCCHs are configured in slot 1 and 2, the WTRU may transmit the multi-slot PUSCH with UCIs piggybacked on slot 1 and 2.

Some implementations include TBS determination. For example, in some implementations, if the WTRU is configured to perform a multi-slot transmission, the WTRU may determine the TBS for the configured multi-slot transmission. In some implementations, the WTRU may receive a configuration for the number of PRBs and slots for the multi-slot transmission from a DCI or semi-static configuration. In some implementations the WTRU may receive a configuration for an amount of physical resources overhead (i.e., resources assumed to be not available for data transmission) it should reserve (i.e., exclude the physical resources overhead from the uplink grant) per slot in the multi-slot transmission when the WTRU determines the TBS. In some implementations, an overhead parameter is signaled from the gNB to the WTRU. In some implementations, the WTRU determines the number of physical resources for data by subtracting the number of overhead resources from the number of resources allocated for PUSCH. In some implementations, the number of resource elements allocated for PUSCH within a PRB in a slot may be given by:

$${{N}^{′}}_{R E} = {N}_{S C}^{R B} {N}_{s y m b}^{s h} - {N}_{D M R S}^{P R B} - {N}_{o h}^{R B}$$

where

$${{N}^{′}}_{R E} , {N}_{S C}^{R B} , {N}_{s y m b}^{s h} , {N}_{D M R S}^{P R B} \text{and} {N}_{o h}^{R B}$$

are the number of resource elements allocated for PUSCH within a PRB, the number of subcarriers in the frequency domain in a PRB, the number of symbols allocated for PUSCH in a slot, the number of resource elements for DM-RS per PRB in the allocated PUSCH duration, and the overhead configured by the higher layer, respectively. In some implementations, the overhead parameter

$${N}_{o h}^{R B}$$

may be determined based on the number and/or amount of resources occupied by other signals or channels, e.g., based on the resources of SRS or PUCCH transmissions in a slot, indicating other signals or channels may be multiplexed in either time or frequency domain with PUSCH. The terms

$${N}_{o h}^{R B} ,$$

“overhead parameter” an “overhead size” may be used interchangeably.

In some implementations, in a multi-slot transmission, the WTRU may receive an indication to apply different overhead parameter values for

$${N}_{o h}^{R B}$$

per slot, or may use the same overhead parameter for all slots in the multi-slot transmission. In some implementations, the WTRU may determine the overhead parameter based on the number of slots configured for the multi-slot transmission. For example, in some implementations, the WTRU may determine

$${N}_{o h}^{R B}$$

for each slot in the multi-slot transmission based on at least one of the following methods: the WTRU may include the overhead

$${N}_{o h}^{R B}$$

in preconfigured slots in the multi-slot transmission; the WTRU may determine to use the same overhead size in all slots in the multi-slot transmission; and/or the WTRU may scale the overhead by the number of slots configured for the multi-slot transmission.

In some implementations where the WTRU includes the overhead

$${N}_{o h}^{R B}$$

in preconfigured slots in the multi-slot transmission, the WTRU may determine to include the overhead in the first slot in the multi-slot transmission and set the overhead value to zero (i.e.,

$$\left({N}_{o h}^{R B} = 0\right)$$

for the rest of the slots in the multi-slot transmission. In some implementations, the WTRU may determine association of the overhead parameters and slots based on RRC, MAC control element (MAC-CE) or DCI the WTRU receives. The indication of location of slots and overhead size may be indicated by a bitmap and associated overhead size. For example, in a 4-slot multi-slot transmission, an overhead size of

$${N}_{o h}^{R B} = 0$$

may be associated with the bitmap 0111 and an overhead size of

$${N}_{o h}^{R B} = 6$$

may be associated with a bitmap 1000. This example configuration means that the first slot in the multi-slot transmission contains 6 resource elements of overhead and the 2^{nd}, 3^{rd} and 4^{th} slot in the multi-slot transmission do not contain any overhead.

In another example, in some implementations where the WTRU determines to use the same overhead size in all slots in the multi-slot transmission, the WTRU may determine to set

$${N}_{o h}^{R B} = 0$$

(i.e., indicating there is no overhead per slot) for all slots if PUSCH is scheduled for a whole slot (i.e., 14 symbols in PUSCH per slot) in the multi-slot transmission. The WTRU may determine to include the overhead in all slots if the WTRU is configured to perform PUSCH repetition in the multi-slot transmission.

In some implementations, the WTRU may receive an indication to perform at least one of the above overhead determination procedures in a DCI, MAC-CE or RRC signaling. In some implementations, the WTRU may receive the overhead configuration per slot or per multi-slot transmission. In some implementations where the WTRU may receive the overhead configuration per slot or per multi-slot transmission, the WTRU may apply the same overhead parameter for all slots in the multi-slot transmission.

In some implementations, the WTRU may determine the overhead parameter from the aforementioned information elements for PUSCH time domain resource allocation. In some implementations the WTRU may determine the overhead parameter based on one or more of the following conditions: whether slots in the multi-slot transmission are contiguous or not; whether or how many symbols for PUCCH, or reference signals such as SRS, are scheduled in slots in the multi-slot transmission; and/or whether DMRS bundling is enabled for the multi-slot transmission.

After the WTRU determines the overhead parameter from the information elements, the WTRU may determine total number of resource elements in the multi-slot transmission using one or more of several methods. In some implementations, if the same overhead is applied to all slots in the multi-slot transmission, the WTRU may determine the number of resource elements in the multi-slot transmission as

$${{N}^{′}}_{R E} \times N ,$$

where N is the number of slots allocate for the multi-slot transmission. The WTRU, in some cases, does not include any overhead, i.e.,

$${N}_{o h}^{R B} = 0.$$

If multiple PRBs are allocated for the multi-slot transmission, the total number of resource elements may be determined by

$$\left({{N}^{′}}_{R E} \times N\right) \times K ,$$

where K is the number of PRBs allocated for the multi-slot transmission. In some implementations, if the overhead is included in the preconfigured number of slots, M, the WTRU may determine the number of resource elements in the multi-slot transmission by

$${N}_{R E}^{\left(1\right)} \times \left(N - M\right) + {N}_{R E}^{\left(2\right)} \times M \text{where} {N}_{R E}^{\left(1\right)} , {N}_{R E}^{\left(2\right)} ,$$

and N are the number of resource elements per slot which does not include overhead, the number of resource elements per slot which does include overhead, and number of slots allocated for the multi-slot transmission, respectively. If multiple PRBs are allocated for the multi-slot transmission, the total number of resource elements may be determined by

$$\left({N}_{R E}^{\left(1\right)} \times \left(N - M\right) + {N}_{R E}^{\left(2\right)} \times M\right) \times K ,$$

where K is the number of PRBs allocated for the multi-slot transmission.

In some implementations, the WTRU may receive an indication from the network (e.g., gNB) that the number of PRBs allocated for the multi-slot transmission is always 1, e.g., to minimize the usage of resources in the frequency domain. Alternatively, the WTRU may determine that the number of PRBs is 1 by default after the multi-slot transmission is configured.

In some implementations, based on the determined number of total number of resource elements and other transmission related information such as modulation or code rate, the WTRU may determine TBS based on a look-up table.

Some implementations provide a nominal number of slots for transmission and/or retransmission, and a maximum number of additional slots for transmission and/or retransmission. The total number of slots for transmission and/or retransmission, including the nominal number and the additional slots, is referred to as an actual number of slots. For example, in some implementations, the WTRU may be configured with a nominal number of slots for multi-slot uplink (e.g., PUSCH) transmission or retransmission. Such nominal number of slots may be part of the SLIV configuration, or time domain resource allocation (TDRA) configuration, or may be separately indicated by the DCI scheduling, by activating the multi-slot PUSCH transmission or retransmission, or by RRC configuration for configured grant transmission. In some implementations, the nominal number of slots indicates, to the WTRU, the number of slots for multi-slot PUSCH in cases where there is no interruption of the multi-slot PUSCH transmission or retransmission. For example, in a case where the WTRU is configured with a nominal number of slots equal to 3 slots, if the WTRU is interrupted during the multi-slot PUSCH transmission (e.g., by a DL slot due to TDD configuration), the WTRU may use an additional slot to transmit at the end of the indicated number of slots (i.e., the WTRU may use a fifth slot to transmit, in this example). In some implementations, the WTRU may determine (e.g., based on its configuration) a maximum number of additional slots that may be used for multi-slot PUSCH transmission. In some implementations, the maximum number of additional slots for multi-slot PUSCH transmission is based on one or more, or a combination of, an indication of rate matching, puncturing, and/or truncation of part of the allocated resources for multi-slot PUSCH transmission; a number of invalid slots and/or symbols for uplink transmission; and/or a number of remaining symbols configured for the multi-slot PUSCH transmission exceeding the remaining symbols of a slot.

In some implementations where the maximum number of additional slots (or the total, actual number of slots) is determined based on an indication of rate matching, puncturing, and/or truncation of part of the allocated resources for multi-slot PUSCH transmission, the WTRU may receive an indication indicating a part of the resources to be rate matched around, punctured or truncated. In some implementations, the indication may be semi-statically configured. For example, the WTRU may be configured using RRC with a rate matching pattern for LTE CRS. Alternatively, the indication may be transmitted using dynamic signaling. For example, in a case where the WTRU receives a group common DCI indicating interruption, the WTRU may use additional slots to transmit the multi-PUSCH transmission.

In some implementations where the maximum number of additional slots (or the total, actual number of slots) is determined based on a number of invalid slots and/or symbols for uplink transmission, the WTRU may determine the number of valid slots and/or symbols based on the TDD configuration, e.g., including dynamic re-configuration of the TDD structure. For example, the WTRU may receive a slot format indication changing or “flipping” a flexible slot to a downlink slot. Based on the indication, the WTRU may determine that one slot was lost for a downlink transmission and may accordingly use an additional slot at the end of the configured number of nominal number of slots for multi-slot uplink transmission.

In some implementations, the maximum number of additional slots (or the total, actual number of slots) is determined based on a number of remaining symbols configured for the multi-slot PUSCH transmission is greater than the number of remaining symbols in a slot.

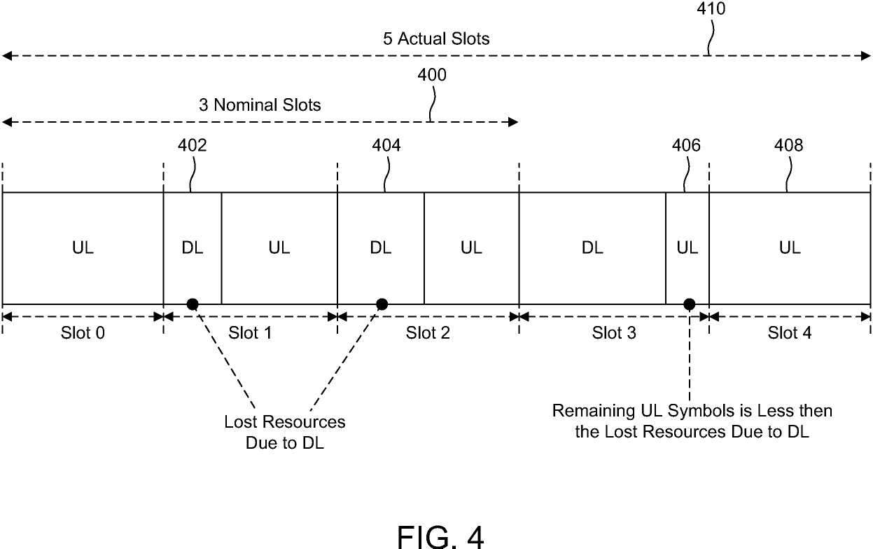

FIG. 4 is a diagram illustrating nominal and actual slots for an example multi-slot PUSCH 400. In the example of FIG. 4, a WTRU is configured with a multi-slot PUSCH transmission of 3 nominal slots 400. Here, nominal slots refers to the number of slots needed to transmit all symbols of the PUSCH transmission. In this example, the WTRU determines that parts 402 and 404, of Slot 1 and Slot 2 respectively, are occupied by DL transmissions (e.g., due to flipping a portion of a flexible slot). Based on this determination, the WTRU selects Slot 3 to transmit the remaining symbols of the multi-slot PUSCH transmission. The WTRU determines that the UL symbols 406 available in Slot 3 are insufficient to transmit the remaining symbols of the multi-slot PUSCH transmission. Here, “remaining symbols” refers to the symbols of the multi-slot PUSCH transmission that were not able to be transmitted in the nominal slots (i.e., parts 402 and 404 of Slot 1 and Slot 2 respectively). Based on this determination, the WTRU also selects Slot 4 to transmit the remaining symbols of the multi-slot PUSCH transmission, where the UL symbols 408 of slot 4 are sufficient to transmit the remaining symbols of the multi-slot PUSCH transmission, yielding a multi-slot PUSCH of 5 actual slots 410. In some implementations, the WTRU may use the determined actual number of slots to transmit the multi-slot PUSCH transmission. In some implementations, the actual number of slots may be contiguous or non-contiguous, e.g., depending on the TDD configuration. Here, TDD configuration indicates the set of slots and/or symbols for downlink, flexible and uplink. For example, one configuration can be DDDUDDDU. In this example case, uplink slots are non-contiguous or non-consecutive.

Some implementations include coded redundancy on separate HARQ processes. Some such implementations include TB splitting and orthogonal coding. For example, for a single MAC PDU generated by the WTRU, the WTRU may split the PDU into multiple coded segments. The WTRU may map the coded segments to different PUSCH transmission occasions associated with different HARQ PIDs. The WTRU may use DFT codes or similar orthogonal coding schemes to produce the coded TB segments. The WTRU may use outer codes or similar block coding schemes to produce coded TB segments. The choice of coding may be predefined or configured by the network. The WTRU may apply such encoding on information bits received from higher layers (e.g., the MAC PDU), on bits after channel coding, and/or on modulated symbols prior to mapping to transmission resource. The WTRU may apply the coding sequence directly to modulated bits. The WTRU may select an orthogonal code and/or the sequence length as a function of the number of bits and/or the MCS.

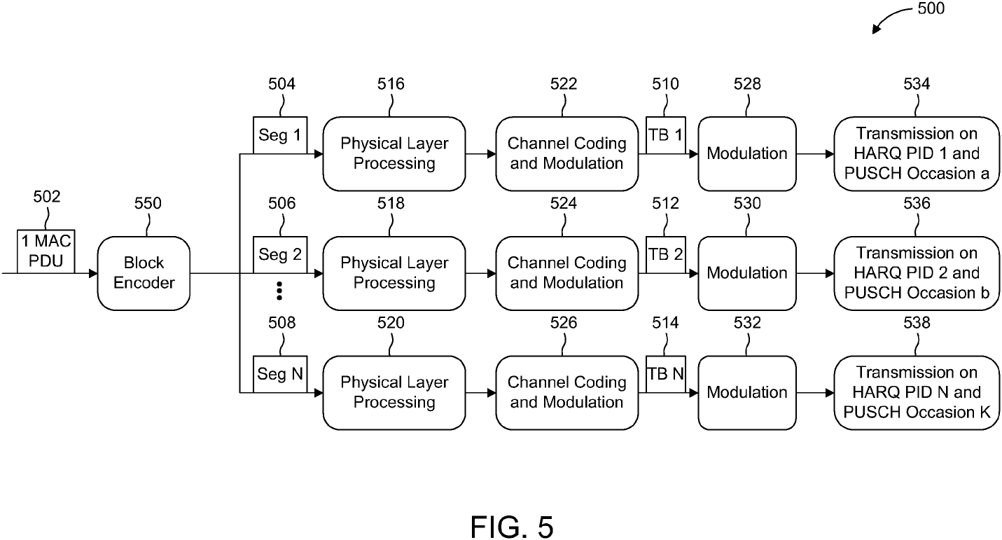

FIG. 5 is a block diagram illustrating an example implementation 500 including outer coding between MAC and PHY. In this example, one MAC PDU is not contained within a single TB because the PDU is coded into multiple PDU segments, each including one TB in this implementation. In this example, the WTRU may segment MAC PDU 502 into N PDU segments 504, 506, 508, by an encoder 550 (e.g., using outer coding, block encoding, or fountain coding, etc.). Each segment 504, 506, 508 is treated as a TB 510, 512, 514, respectively, in the physical layer and is subject to separate physical layer processing 516, 518, 520, respectively, and separate channel coding and modulation, 522, 524, 526, respectively. After this, TBs 510, 512, 514 are subject to separate modulation 528, 530, 532, and the WTRU may transmit each corresponding modulated TB 510, 512, 514, on a different PUSCH occasion HARQ process 534, 536, 538, respectively.

In some implementations, the receiver (e.g., gNB) may configure, signal, or indicate the number of segments N, the number of applicable segments, the applicable PUSCH occasions, and/or the number of applicable HARQ PIDs. The receiver may decode the PDU, e.g., if it receives a number of PDU segments <= N successfully. The gNB may issue a retransmission grant for a given HARQ process ID, whereby the WTRU can retransmit the PDU segment (i.e., the TB) associated with that HARQ process ID. For such retransmissions, the WTRU MAC may either store each PDU segment/TB in the associated HARQ buffer or store the whole PDU in a single HARQ buffer. If a retransmission is invoked, the WTRU MAC may provide the whole PDU to PHY and the WTRU PHY may reproduce the requested segment/TB for retransmission, or the WTRU MAC may only provide the requested PDU segment to PHY for retransmission.

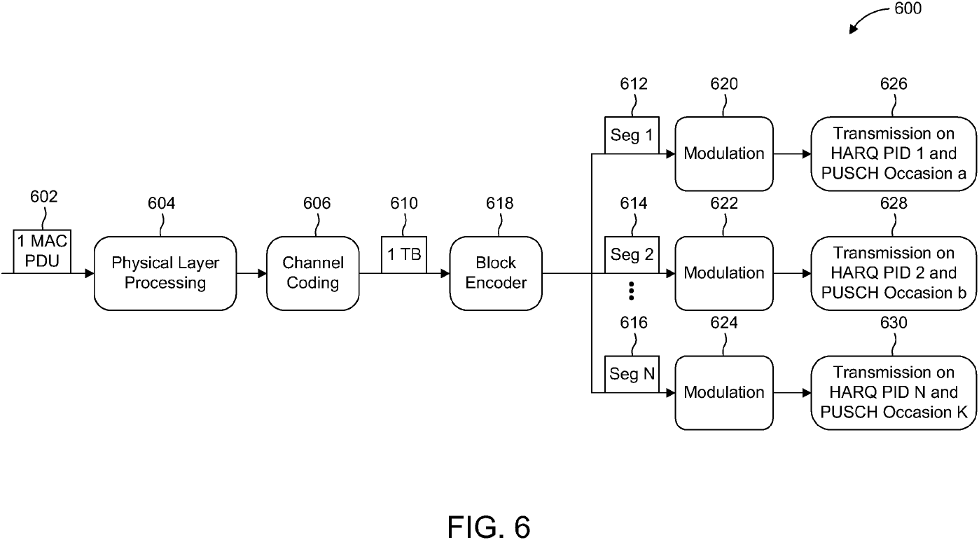

FIG. 6 is a block diagram illustrating an example implementation 600 including outer coding after channel encoding. In this example, a MAC PDU 602 is subject to physical layer processing 604 and channel coding 606. At this stage, the MAC PDU 602 is contained within one TB 610. After channel coding 606, the WTRU segments TB 610 into N TB segments 612, 614, 616, using block encoder 618 (e.g., using outer coding, block encoding, or fountain coding, etc.). After this, the WTRU may subject each TB segment 612, 614, 616 to separate modulation 620, 622, 624 and transmit each modulated TB segment 612, 614, 616 on a different PUSCH occasion and a different HARQ process 626, 628, 630, respectively.

In some implementations, the receiver (e.g. gNB) may configure, signal, or indicate the number of segments N, the number of applicable segments, PUSCH occasions, and HARQ PIDs. The receiver may decode the PDU, e.g., if it receives a number of TB segments <= N successfully. The receiver (e.g., gNB) may issue a retransmission grant for a given HARQ process ID, whereby the WTRU can retransmit the TB segment associated with that HARQ process ID. If a retransmission is invoked, the WTRU PHY may reproduce the requested TB segment for retransmission, if not already stored in the associated HARQ buffer.

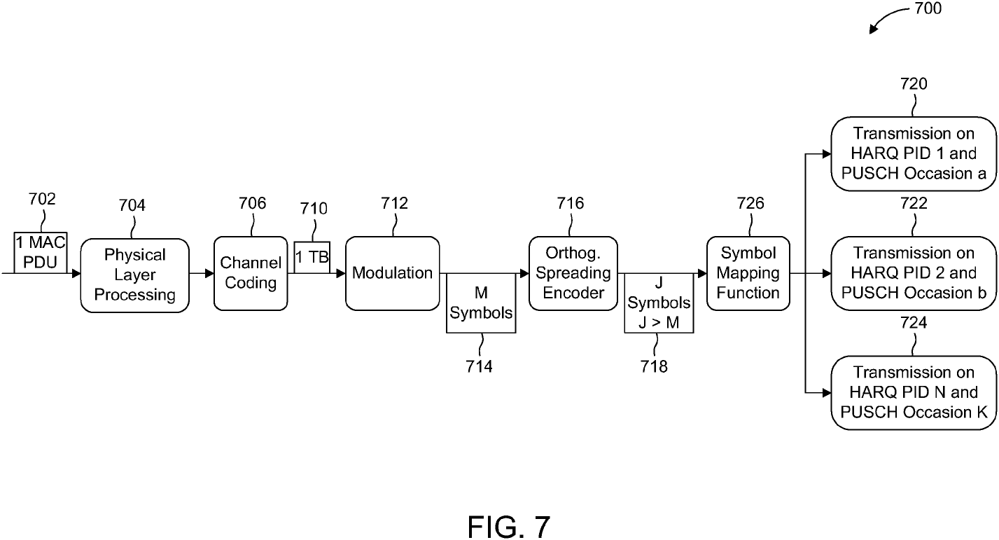

FIG. 7 is a block diagram illustrating an example implementation 700 including orthogonal coding after modulation and channel encoding by applying a phase rotation to base sequence or an orthogonal code operating on OFDM symbols output (e.g., DFT codes).

In this example, a MAC PDU 702 is subject to physical layer processing 704, channel coding 706, and modulation 608 At this stage, the MAC PDU 702 is contained within one TB 710. Channel modulation 712 is applied to the MAC PDU after channel coding 706, generating M modulated symbols 714. After modulation 712, the WTRU may apply a spreading orthogonal code to the M modulated symbols 714 using orthogonal spreader 716 to generate J symbols 718, where J > M. The WTRU may transmit the J symbols on N different PUSCH occasions (or TTIs) and HARQ processes 720, 722, 724. The WTRU may map the J symbols 718 to the PUSCH occasions and HARQ processes 720, 722, 724 based on a symbol-to-PUSCH occasion mapping function 726.

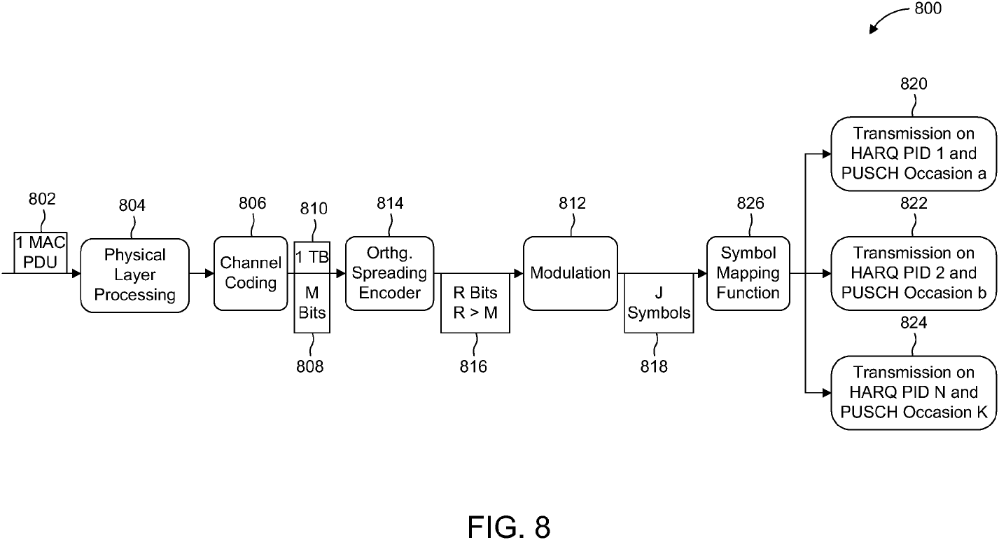

FIG. 8 is a block diagram illustrating an example implementation 800 including orthogonal coding after channel encoding. In this example, a MAC PDU 802 is subject to physical layer processing 804 and channel coding 806, generating M channel encoded bits 808. At this stage, the MAC PDU 802 is contained within one TB 810. After channel coding 806, but before modulation 812, the WTRU may apply a spreading orthogonal code 814 to the M channel encoded bits 808 to generate R orthogonal coded bits 816, where R > M. Modulation 812 is applied to the R orthogonal coded bits 816 to generate J symbols 818. The WTRU may transmit the J symbols 818 on different PUSCH occasions (or TTIs) and different HARQ processes 820, 822, 824. The WTRU may map the J symbols 818 to the PUSCH occasions and HARQ processes 820, 822, 824 based on a symbol-to-PUSCH occasion mapping function 826.

In the examples described with respect to FIGS. 7 and 8, the receiver (e.g. gNB) may signal and/or configure N, the number of applicable PUSCH occasions, and HARQ PIDs, and/or the encoding ratio. The receiver (e.g., gNB) may multiplex another WTRU on the same resource; e.g., using a different code from the same base sequence. In some implementations, mapping function (726 or 826) may map a number of symbols J per PUSCH occasion N, may map the symbols sequentially by order of time into the applicable PUSCH occasions, or may map the symbols by order of frequency first then by PUSCH occasion. The gNB may issue a retransmission grant for a given HARQ process ID or a given slot, whereby the WTRU can retransmit the symbols associated with that slot and/or HARQ process ID. If a retransmission is invoked, the WTRU PHY may reproduce the requested symbols associated with the HARQ process and/or the PUSCH occasions on which the retransmission is requested, if not already stored in the associated HARQ buffer.

Some implementations include mapping of coded TB segments to different TTIs associated with different HARQ processes. In some implementations, the WTRU may allocate each segment on a different PUSCH occasion. For example, for a multi-TTI grant (e.g., a 3GPP NR R16 multi-TTI grant), the WTRU may allocate each coded TB segment to a different PUSCH occasion of the multi-TTI grant signaled by the single DCI, whereby each TTI may correspond to a different HARQ PID. Each TB segment may be mapped for transmission on a different HARQ process.

In some implementations, the WTRU may transmit TB segments non-continuously in the time domain and/or on different frequency regions/PRBs, e.g., for additional coverage enhancements (e.g., for diversity against fading, interference and/or link blockage). The WTRU may transmit the coded TB segments on CG occasions of different HARQ processes, (e.g., on the same CG on different time occasions that correspond to different HARQ PIDs). For example, the WTRU may create a TB according to a multiple of the TBS of the CG. After this, the WTRU may produce coded TB segments of the same size as the TBS of the CG, whereby each segment is transmitted on a CG occasion continuously (e.g., on different HARQ PIDs).

Some implementations include maintenance of HARQ process buffers. For example, in some implementations, the WTRU may store the total TB or PDU using the first HARQ process used to transmit the first TB segment, or any single HARQ PID associated with the TB. However, the WTRU may retransmit a TB segment according to the HARQ PID associated with a retransmission grant. In some implementations, the WTRU may store each coded PDU segment in the HARQ process on which it is transmitted.

In some implementations, the WTRU may flush the HARQ buffer of all associated HARQ processes after determining an ACK of any HARQ process associated with the TB. The WTRU may determine an ACK of a HARQ process in any suitable manner (e.g., by receiving an ACK, a toggled NDI, expiry of a timer, etc.). The WTRU may flush the HARQ buffer of all associated HARQ processes after determining an ACK for the HARQ process ID used to store the TB in the WTRU buffer. In some implementations, the WTRU may assume that the whole TB was not successfully decoded (e.g., may determine NACK) if a retransmission grant was issued for any HARQ PID associated with the TB and/or NDI is not toggled. The WTRU may alternatively maintain HARQ-ACK for each TB segment, e.g., for each associated HARQ PID. The WTRU may retransmit (e.g., only) the TB segment associated with the HARQ processes signaled for, or associated with, a retransmission grant.

In some implementations, if TB segments were transmitted on different CG occasions with different HARQ processes, the WTRU may start, or re-start, the CG timer each time a transmission or retransmission is made on any of the HARQ processes used to transmit the PDU segments. The WTRU may restart the CG timer and/or CGRT for all HARQ processes associated with the TB if a retransmission grant was issued for any HARQ PID associated with the TB and/or NDI is not toggled. The WTRU may stop the CG timer and/or CGRT for all HARQ processes associated with the TB if ACK is determined for the whole PDU (i.e., for all TB segments).

Some implementations include coded redundancy within a single HARQ process. In some implementations, the WTRU may generate at least one coded segment for a transport block, e.g., as described herein. In some implementations, the WTRU may map each coded segment’s modulated symbols to a different slot, using a configuration of RS which may be specific to each slot.

In some implementations, the WTRU may determine a single HARQ process for all coded segments. In some implementations, the WTRU may determine the applicable HARQ process from a DCI in dynamic grant cases, or from a formula in a configured grant cases. In configured grant cases, in some implementations, the HARQ process may be the one obtained for the first slot or first symbol when applying the formula.

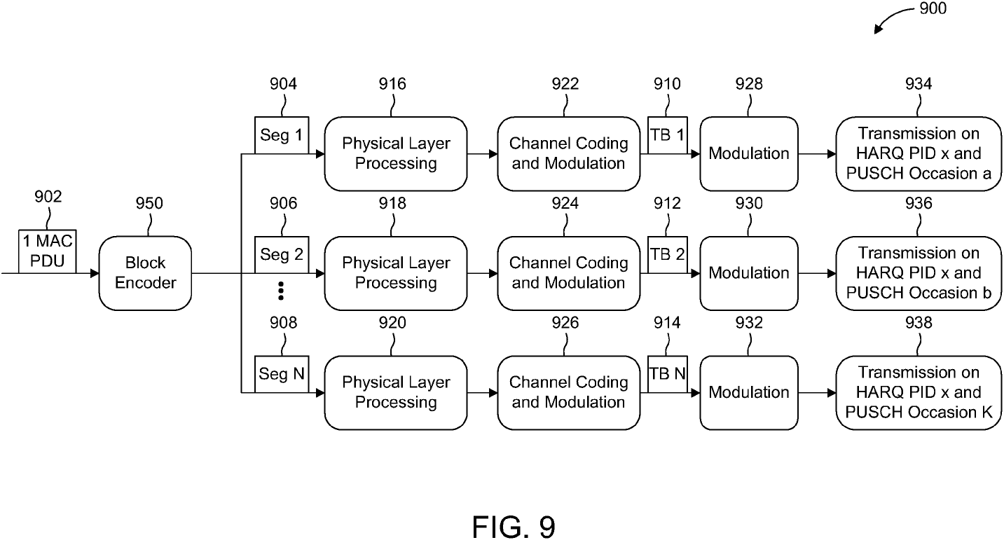

FIG. 9 is a block diagram illustrating an example implementation 900 including outer coding between MAC and PHY. In this example, the WTRU may segment a MAC PDU 902 into N segments 904, 906, 908, by an encoder 950 (e.g., using outer coding, block encoding, or fountain coding, etc.) Each segment 904, 906, 908 Each segment 904, 906, 908 is treated as a TB 910, 912, 914, respectively, in the physical layer, and is subject to separate physical layer processing 916, 918, 920, respectively, and separate channel coding and modulation, 922, 924, 926, respectively. After this, TBs 910, 912, 914 are subject to separate modulation 928, 930, 932, and the WTRU may transmit each corresponding modulated TB, 910, 912, 914, on a different PUSCH occasion, but using the same HARQ process, 934, 936, 938, respectively.

In some implementations, the receiver (e.g., a gNB) can signal, to the WTRU, a number N, the number of segments applicable for PUSCH occasions, and the applicable HARQ PID. The receiver may decode the PDU if it receives a number of PDU segments <= N successfully. The gNB may issue a retransmission grant for a given PDU segment, whereby the WTRU can retransmit the PDU segment (i.e., the TB) associated with the indicated segment. For such retransmission, the WTRU MAC may store the whole PDU in a single HARQ buffer. If a retransmission is invoked for a given segment, WTRU MAC may provide the whole PDU to PHY and the WTRU PHY may reproduce the requested segment/TB for retransmission, or the WTRU MAC may only provide the requested PDU segment to PHY for retransmission.

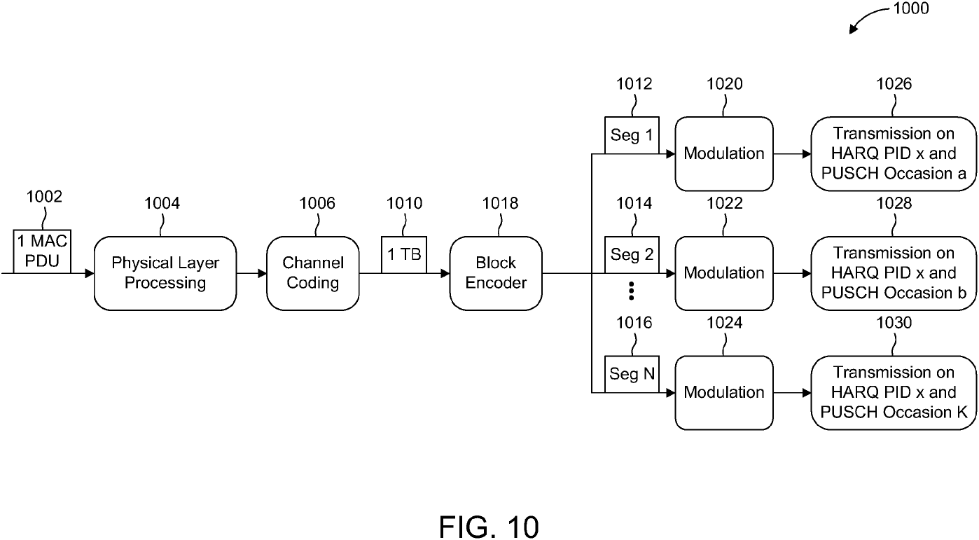

FIG. 10 is a block diagram illustrating example implementation 1000 including outer coding after the channel encoding. In this example, a MAC PDU 1002 is subject to physical layer processing 1004 and channel coding 1006. At this stage, the MAC PDU 1002 is contained within one TB 1010. After channel coding 1006, the WTRU segments TB 1010 into N TB segments 1012, 1014, 1016, using block encoder 1018 (e.g., using outer coding, block encoding, or fountain coding, etc.). After this, the WTRU may subject each TB segment 1012, 1014, 1016 to separate modulation 1020, 1022, 1024 and transmit each modulated TB segment 1012, 1014, 1016 on a different PUSCH occasion but using the same HARQ process 626, 628, 630, respectively.

In some implementations, the receiver (e.g., a gNB) may configure, signal, or indicate the number of segments N, the number of applicable segments, PUSCH occasions, and the applicable HARQ PID. The receiver may decode the PDU, e.g., if it receives a number of TB segments <= N successfully. The receiver (e.g., gNB) may issue a retransmission grant for a given TB segment, whereby the WTRU can retransmit the TB segment associated with the indicated TB segment. If a retransmission is invoked, the WTRU PHY may reproduce the requested TB segment for retransmission.

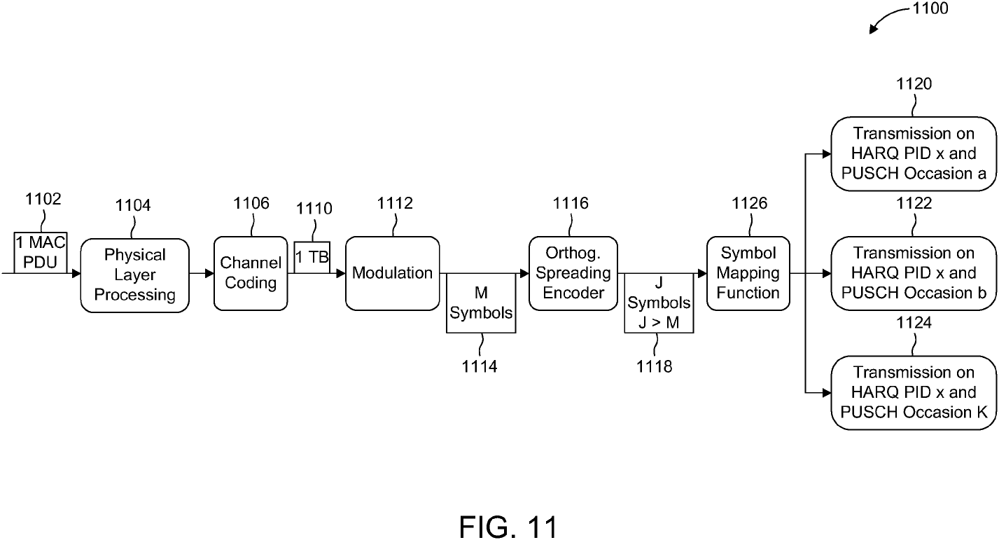

FIG. 11 is a block diagram illustrating example orthogonal coding after modulation and channel encoding by applying a phase rotation to base sequence or a code operating on OFDM symbols output (e.g., DFT codes etc.).

In this example, a MAC PDU 1102 is subject to physical layer processing 1104, channel coding 1106, and modulation 1108 At this stage, the MAC PDU 1102 is contained within one TB 1110. Channel modulation 1112 is applied to the MAC PDU after channel coding 1106, generating M modulated symbols 1114. After modulation 1112, the WTRU may apply a spreading orthogonal code to the M modulated symbols 1114 using orthogonal spreader 1116 to generate J symbols 1118, where J > M. The WTRU may transmit the J symbols on N different PUSCH occasions (or TTIs) but using the same HARQ process 1120, 1122, 1124, respectively. The WTRU may map the J symbols 1118 to the PUSCH occasions based on a symbol-to-PUSCH occasion mapping function 1126.

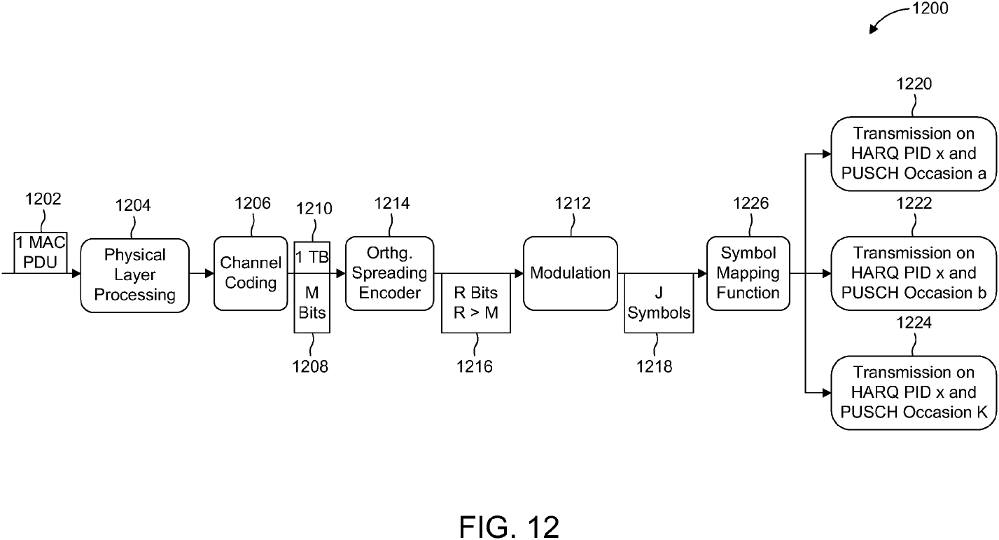

FIG. 12 is a block diagram illustrating example orthogonal coding after channel encoding. In this example, a MAC PDU 1202 is subject to physical layer processing 1204 and channel coding 1206, generating M channel encoded bits 1208. At this stage, the MAC PDU 1202 is contained within one TB 1210. After channel coding 1206, but before modulation 1212, the WTRU may apply a spreading orthogonal code 1214 to the M channel encoded bits 1208 to generate R orthogonal coded bits 1216, where R > M. Modulation 1212 is applied to the R orthogonal coded bits 1216 to generate J symbols 1218. The WTRU may transmit the J symbols 1218 on different PUSCH occasions (or TTIs) but the same HARQ process 1220, 1222, 1224. The WTRU may map the J symbols 1218 to the PUSCH occasions and HARQ process 1220, 1222, 1224 based on a symbol-to-PUSCH occasion mapping function 1226.

For the examples illustrated in FIGS. 11 and 12, the receiver (e.g., gNB) may signal and/or configure N, the number of applicable PUSCH occasions, the applicable HARQ PID, and/or the encoding ratio. The receiver (e.g., gNB) may multiplex another WTRU on the same resource; e.g., using a different code from the same base sequence. In some implementations, the mapping function (1126, 1226) may map a number of symbols J per N PUSCH occasions, or may map the symbols sequentially by order of time into the applicable PUSCH occasions. The gNB may issue a retransmission grant for a given slot or PUSCH occasion, whereby the WTRU can retransmit the symbols associated with that slot/PUSCH occasion. If a retransmission is invoked, the WTRU PHY may reproduce the requested symbols associated with the PUSCH occasions on which the retransmission is requested.

Some implementations include mapping of coded TB segments to different TTIs associated with the same HARQ process. In some implementations, the WTRU may allocate each segment on a the PUSCH occasion. For example, for a multi-TTI grant with slot aggregation (e.g., a 3GPP R15 multi-TTI grant with slot aggregation), the WTRU may allocate each coded TB segment to a different PUSCH occasion of the multi-TTI grant signaled by the single DCI, whereby each TTI may correspond to the same HARQ PID.

In some implementations the WTRU may transmit TB segments non-consecutively in the time domain and/or on different frequency regions/PRBs for additional coverage enhancements (e.g., for diversity against fading, interference and/or link blockage). The WTRU may transmit the coded TB segments on CG occasions of same HARQ PID, possibly on the same CG. The WTRU may assume the same HARQ PID is used for consecutive occasions, and thus ignore the HARQ PID determination formula for transmission of subsequent TB segments.

In some implementations the WTRU may assume that the whole TB was not successfully decoded (e.g., may determine NACK) if a retransmission grant was issued for any TB segment. The WTRU may maintain a sub HARQ-ACK status (i.e., ACK or NACK) for each TB segment, where a sub HARQ-ACK refers to a different HARQ-ACK status for each TB segment. In some implementations, the WTRU may retransmit only the TB segment associated with the associated PUSCH occasion used to transmit the TB segment.

Some implementations include grouping of coded and modulated bits. For example, in some implementations, a WTRU may receive an indication (e.g., from a gNB or other network device) to group a set of coded and modulated bits of a transport block. For example, in some implementations, the WTRU may be configured to associate a group index to the grouped coded and modulated bits. In some implementations, the WTRU may group the coded and modulated bits based on the slot on which they are mapped during the initial transmission; based on the set of symbols on which they are mapped during the initial transmission; and/or based on the type of resources on which the coded and modulated bit are mapped into.

In some implementations, for example, where the WTRU groups the coded and modulated bits based on the slot on which they are mapped during the initial transmission, the WTRU may determine the initial transmission based on the New Data Indicator (NDI) field.

In some implementations, for example, where WTRU groups the coded and modulated bits based on the set of symbols on which they are mapped during the initial transmission, the set of symbols may be smaller than a slot duration (i.e., 14 symbols) or larger than the slot duration, and/or size of the set of symbols can be configured semi-statically or dynamically indicated using the scheduling DCI.

In some implementations, for example, where WTRU groups the coded and modulated bits based on the type of resources on which the coded and modulated bit are mapped into, the type may include, for example, whether they are mapped into a flexible slot, slots, symbol, or symbols. For example, in some implementations a WTRU may be configured with a TDD configuration consisting of a set of DL slots/symbols, a set of flexible slots and/or symbols and a set of UL slots and/or symbols. When receiving, or after receiving a multi-slot PUSCH grant, the WTRU may group the coded and modulated bits into a first group that are mapped onto flexible resources and a second group that are mapped onto uplink resources.

Some implementations include retransmission of a group of coded and modulated bits. For example, in some implementations, a WTRU may be configured to retransmit only a group or groups of coded and modulated bits transmitted during an initial transmission. In some implementations, when or after receiving a grant for retransmission, a WTRU may receive a bit field in the DCI indicating the group of indices that are requested for retransmission. In some implementations, alternatively, a WTRU may be configured to autonomously determine the groups needed for retransmission. In some implementations, a WTRU may determine that a group or groups are to be retransmitted if the WTRU was not able to initially transmit the group. In some implementations, for example, a group of coded and modulated bits are initially mapped to flexible slots and/or symbols. In some implementations, for example, after receiving the UL grant, the WTRU determines that UL transmissions are not allowed on flexible resources (e.g., based on an indication or a configuration, e.g., received from a gNB or other network device). In some implementations, the WTRU may determine to transmit the part of the TB that was not transmitted on flexible slots (e.g., due to not receiving an indication or slot format indicator (SFI) indicating the slot as an UL slot) in a second grant over a second set of slots, e.g., if the second grant matches the size and/or the number of slots that were not indicated as an uplink part of the first set of slots.

In some implementations, a WTRU may receive an UL grant for retransmission that has a larger number of resources that the resources needed to retransmit a group of coded and modulated bits. In some implementations, a WTRU may be configured to repeat the coded and modulated bits until the WTRU fills the scheduled resources. In some implementations, for example, a WTRU may receive an UL grant with 14 symbols for retransmission. In some implementations, the WTRU may determine that, for the requested group for retransmission, 7 symbols are needed. In some implementations, after determining that 7 symbols are needed, the WTRU transmits the group twice (i.e., uses the 14 symbols to transmit the group two times.) In other implementations, a WTRU may be configured to transmit additional redundancy version bits in the UL grant for retransmission. In some implementations, the WTRU may determine the number of RV bits to be transmitted based on the remaining resources after mapping the requested group. In some implementations, the WTRU may be configured to group a set of coded and modulated bits per slot. The WTRU may receive an indication to retransmit a group or groups of coded and modulated bits. The indication may be signaled by a DCI, and/or may accompany a retransmission grant. The indication may also indicate a number of slots (e.g., slot indices). The WTRU may determine the group or groups to be retransmitted based on the set of slots interrupted. The WTRU may receive an indication to retransmit the part of the TB which was transmitted over the indicated slots.

Some implementations include various procedural aspects. For example, some implementations include dynamic indication of sequence selection and resource allocation. In some implementations, the WTRU may receive a dynamic indication and/or signaling indicating the number of slots on which the TB is transmitted, whether TB segmentation is used, the repetition type, whether an interleaving is used, whether frequency hopping is used, and/or the number of the identities of associated HARQ processes.

In some implementations, the WTRU may select an orthogonal sequence to code the modulated PUSCH bits according to the number of scheduled slots, whether interleaving is applied (e.g., for RS transmission), MCS, measurement gaps, and/or number of PUSCH occasions applicable for transmission of modulated data bits. The WTRU may be configured semi statically to apply coded redundancy for a subset of LCHs, and/or on a subset of CGs. The WTRU may be configured semi-statically with coded redundancy parameters for CGs, including a set of applicable HARQ processes, the sequence to be used, the RV pattern, the number of segments/coded repetitions etc.

Some implementations include reuse of remaining scheduled PUSCH occasions for a different PDU. For example, in some implementations, the WTRU may use remaining scheduled HARQ processes and PUSCH occasions associated with the TB for a different MAC PDU. For example, when a number of segments are successfully decoded (e.g., ACK is received or determined for the whole PDU by the WTRU in response to a transmitted PUSCH), the WTRU may use remaining scheduled HARQ processes and PUSCH occasions associated with the acknowledged TB for a different MAC PDU. In some implementations, the WTRU may map a different generated TB, or a new TB, if the TB has the same RV and TBS as signaled.

Some implementations have an impact on higher layers. For example, some implementations have an impact on HARQ process ID-specific timers. In some implementations, a WTRU MAC may maintain timers associated with a single HARQ process. For PDUs associated with multiple HARQ PIDs (e.g., per the description above regarding coded redundancy on separate HARQ processes), the WTRU may treat MAC timers for all HARQ PIDs associated with the PDU in the same manner. For example, the WTRU may stop or start (or restart) the timers for all HARQ PIDs associated with the PDU simultaneously.

In some implementations, the WTRU may stop or start (or restart) DRX timers for all HARQ PIDs associated with the PDU if the PDU or a PDU segment is transmitted (or retransmitted), and/or if a HARQ ACK is provided or determined for the PDU. This may include, for example, a drx-HARQ RTT Timer and/or drx-RetransmisisonTimer parameter, among others.

The WTRU may stop or start (or restart) timers associated with a configured grant for all HARQ PIDs associated with the PDU when the PDU or a PDU segment is transmitted or retransmitted, and/or when HARQ ACK is provided for the PDU. This may include a configured grant (CG) timer, or configured grant retransmission (CGRT) timer, among others.

Some implementations provide Uplink Control Information (UCI) multiplexing with multi-slot PUSCH transmission. For example, in some implementations the WTRU may be configured with a PUCCH transmission overlapping with a multi-slot PUSCH transmission. In such case, the WTRU may be configured to transmit the UCI of the PUCCH transmission on the multi-slot PUSCH transmission.

Some implementations provide slot selection for UCI multiplexing. For example, in some implementations, a WTRU may be configured to select a slot, from the multiple slots configured for PUSCH transmission, on which to multiplex the UCI. In some implementations, a WTRU may be configured to select the slot based on the timing of the PUCCH transmission. In some implementations, the WTRU may be configured to select the first slot of the multi-slot PUSCH transmission that starts after a duration T of the configured PUCCH transmission. In some implementations, the duration T can be configured semi-statically to the WTRU, e.g., using RRC signaling or a fixed value in the specification. In some implementations, the WTRU may be configured to select the slot based on the number of uplink symbols allocated within the slot. In some implementations, the WTRU may be configured to select the slot with the larger number of uplink symbols. In some implementations, the WTRU may be configured to select the slot with the smallest number of interrupted symbols. In some implementations, the interrupted symbols can be symbols configured for downlink transmission or for a higher priority uplink transmission including other WTRU transmissions.

Some implementations provide UCI spreading over multiple slots. For example, in some implementations, a WTRU may be configured to transmit the UCI over multiple slots of the multi-slot PUSCH transmission. In some implementations, a WTRU may transmit on each slot part of the UCI bits. In some implementations, the WTRU may be configured to select the first slot on which WTRU starts UCI transmission based on the timing of the PUCCH transmission. In some implementations, the WTRU may select the first slot of the multi-slot PUSCH transmission that starts after a duration T of the configured PUCCH transmission. In some implementations, the duration T can be configured semi-statically to the WTRU using RRC signaling or a fixed value in the specification. In some implementations, the WTRU may be configured to select the amount of re-sources reserved for UCI within a slot as a percentage of the available uplink symbols on the slot. In some implementations, for each slot of the multiple slots selected for UCI transmission, the WTRU uses the same percentage of the available uplink symbols.

In some implementations, a WTRU may be configured to enable or disable UCI spreading over multiple slots based on the latency requirement of the UCI. For example, in some implementations, for low-latency UCI requirements, the WTRU is not allowed to use UCI spreading over multiple slots.

Some implementations provide UCI repetition over multiple slots. For example, in some implementations, a WTRU may be configured to repeat a UCI over multiple slots of the multi-slot PUSCH transmission. In some implementations, the gNB configuration of an overlapping PUCCH with multi-slot PUSCH transmission can be or include an implicit indication of UCI repetition. In some implementations, the WTRU may be configured to select the first slot on which WTRU starts a UCI transmission based on the timing of the PUCCH transmission. In some implementations, the WTRU may select the first slot of the multi-slot PUSCH transmission that starts after duration T of the configured PUCCH transmission. In some implementations, duration T can be configured semi-statically to the WTRU, e.g., using RRC signaling or a fixed value in the specification. In some implementations, the WTRU may be configured to repeat a UCI over a number of slots that is lesser than the available number of slots for multi-slot PUSCH transmission. For example, in some implementations, the WTRU is configured with 4 slots for multi-slot PUSCH transmission and an overlapping PUCCH transmission on the first slot. In some implementations, the WTRU determines that the second slot of the multi-slot PUSCH transmission is to be used for the first UCI transmission. In some implementations, the WTRU repeats the UCI two times and uses only the second and third slot of the multi-slot PUSCH transmission. In some implementations, the number of slots for UCI repetition on a multi-slot PUSCH transmission can be semi-statically configured. Additionally or alternatively, in some implementations, the number of slots for UCI repetition on a multi-slot PUSCH transmission can be dynamically indicated to the WTRU. For example, in some implementations, the DCI scheduling the multi-slot PUSCH transmission can indicate the number of slots for UCI repetition. In some implementations, a new field (e.g., a new bit field) in the DCI can be implemented, or an existing field (e.g., an existing bit field) in the DCI can be re-used, e.g., to indicate a number of number of slots for UCI repetition. For example, in some implementations, a Downlink Assignment Indication (DAI) field can be re-used to indicate the number of slots for UCI repetition.

Some implementations provide rate matching adaptation. For example, in some implementations, a WTRU may split the generated coded bit of a transport block into sub-groups and map the sub-groups into a set of symbols and/or of a transmission occasion (e.g., where a transmission occasion is or includes of a set of symbols and/or a set of one or more slots). In some implementations, a WTRU may be configured to perform rate matching of the sub-group of coded bits per occasion. In some implementations, at the start of each occasion, the WTRU excludes the resource elements of the UCI transmission and rate match on the available resources. Alternatively or additionally, in some implementations the WTRU may puncture the allocated resources on the transmission occasion to reserve resources for UCI transmission. In some implementations, a WTRU may be configured to firstly assume a set of resource elements (REs) per occasion and perform a first pass of rate matching. In some implementations, at the beginning of each slot, the WTRU may perform a second round of rate matching if UCI is to be transmitted on the slot/transmission occasion.

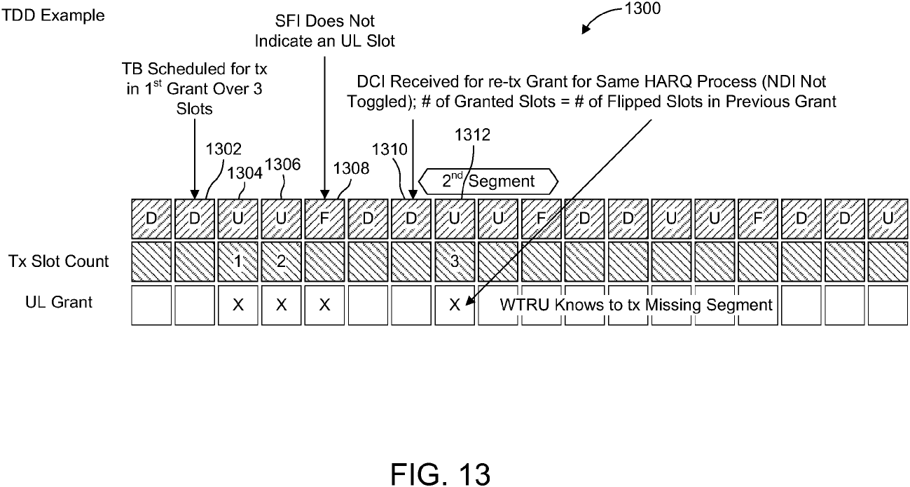

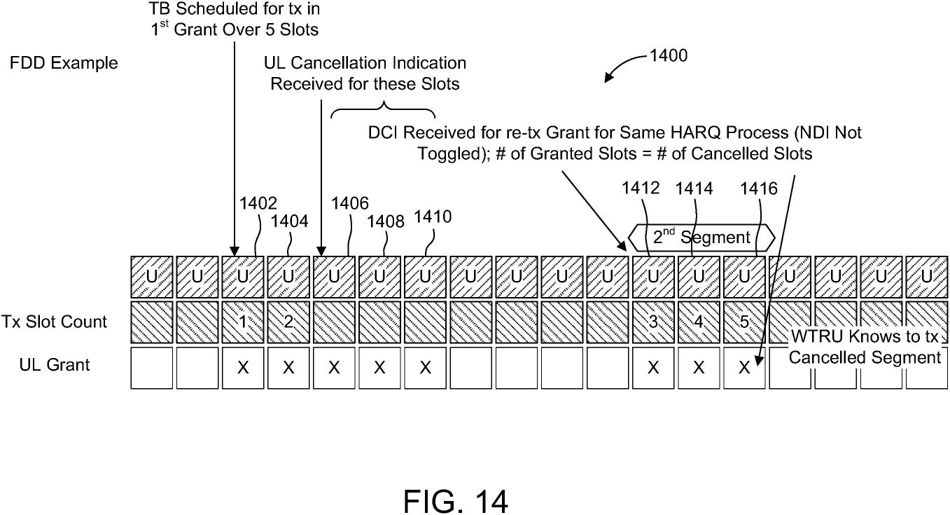

FIGS. 13 and 14 illustrate examples of scheduling a TB over multiple slots. For a TB transmitted by a WTRU over multiple slots, the WTRU determines to transmit or retransmit a dropped TB segment on a later grant using the same HARQ process if the later grant indicates retransmission (e.g., NDI is not toggled), the grant is for the same number of slots as were dropped, and the grant size is large enough.

FIG. 13 is a block diagram illustrating example transmissions 1300 in a time domain duplex (TDD) case. In the figure, slots marked D are downlink, and slots marked U are uplink. In slot 1302, the WTRU receives a DCI including an uplink grant for transmitting a TB over 3 slots 1302, 1304, 1306. SFIs for slots 1302 and 1304 indicates that these are uplink slots, and an SFI for slot 1306 indicates that this is not an uplink slot (e.g., because it is a flexible slot that was flipped to downlink). Accordingly, the WTRU segments the TB into two segments. The WTRU transmits the first segment of the TB in a first slot 1304 and second slot 1306 of the uplink grant. Since the SFI does not indicate that the next slot 1308 of the uplink grant is an uplink slot, the second segment of the TB is dropped. In slot 1310, the WTRU receives a DCI including a retransmission uplink grant for the same HARQ process as the grant received in slot 1302 (indicated by NDI not being toggled in this example). The retransmission grant is also for the same number of slots as were dropped for the grant received in slot 1302. Based on this information, the WTRU determines to retransmit the second segment of the TB in slot 1312.

FIG. 14 is a block diagram illustrating example transmissions 1400 in a frequency domain duplex (FDD) case. In the figure, all slots are marked as uplink (U) slots. Prior to slot 1402, the WTRU receives a DCI in a downlink symbol, the DCI including an uplink grant for transmitting a TB over 5 slots 1402, 1404, 1406, 1408, 1410. Prior to transmission of the TB (or the entire TB), the WTRU receives an UL cancellation indication for slots 1406, 1408, 1410) Accordingly, the WTRU segments the TB into two segments. The WTRU transmits the first segment of the TB slots 1404 and 1406 of the uplink grant, and the second segment of the TB is dropped. After the second segment is dropped, the WTRU receives a DCI in a downlink symbol, the DCI including a retransmission uplink grant for the same HARQ process as the grant received prior to slot 1402 (indicated by NDI not being toggled in this example). The retransmission grant is also for the same number of slots as were dropped for the grant received prior to slot 1402. Based on this information, the WTRU determines to retransmit the second segment of the TB in slots 1412, 1414, 1416.

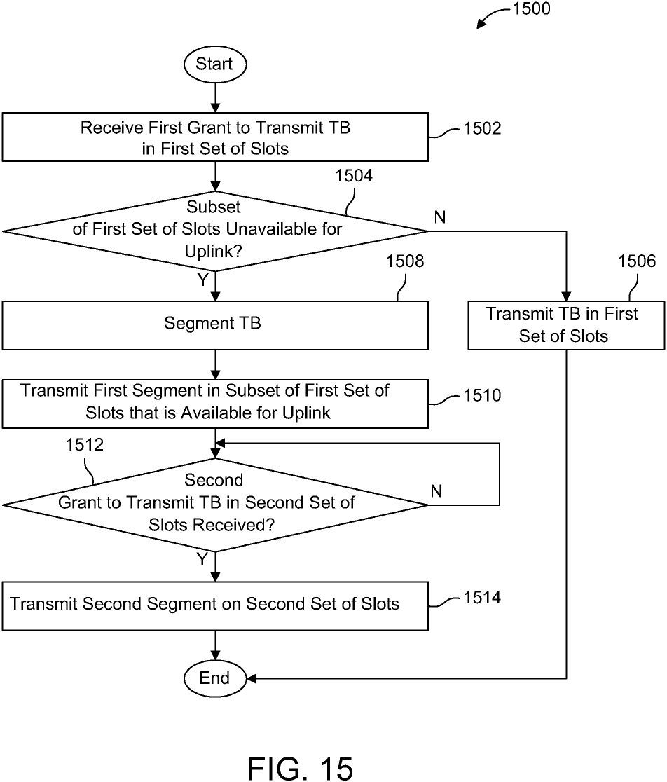

FIG. 15 is a flow chart illustrating an example method for transmitting a TB over multiple slots. In step 1502, a WTRU receives a first grant to transmit a TB in a first set of slots. On condition 1504 that all of the slots are available for uplink, the WTRU transmits the entire TB in the first set of slots in step 1506. On condition 1504 that a subset of the first set of slots is unavailable for uplink, the WTRU segments the TB into a first segment and a second segment in step 1508. In some implementations, the first segment is of a size that fits into a first subset of the first set of slots that is available for uplink. In some implementations, the first segment is of a size that is equal to the amount of data that is possible to transmit in the first subset.

In step 1510, the WTRU transmits the first segment of the TB in the first subset of the first set of slots. On a condition 1512 that a second grant to transmit the TB in a second set of slots is received, the WTRU transmits the second segment of the second set of slots in step 1514. In some implementations, the WTRU determines that the second grant is for transmitting the TB in a second set of slots if the second grant is for the same HARQ process as the first grant (e.g., NDI is not toggled), the second grant provides an amount of uplink resources equal to or greater than the second segment of the TB, and/or the second grant is for a number of uplink slots that is equal to or greater than the subset of the first set of slots that is unavailable for uplink.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1-20. (canceled)

21. A method implemented in a wireless transmit/receive unit (WTRU), the method comprising:
receiving a first grant for a first set of slots, wherein the first grant is associated with a hybrid automatic repeat request (HARQ) process;
determining that a first subset of the first set of slots is available for uplink transmission and that a second subset of the first set of slots is unavailable for uplink transmission;
transmitting a first segment of a transport block (TB) in the first subset of the first set of slots;
receiving a second grant for a second set of slots, wherein the second grant is associated with the HARQ process; and
transmitting a second segment of the TB in the second set of slots based on the second grant being associated with the HARQ process.

22. The method of claim 21, wherein the second segment of the TB is not sent in the first set of slots, and the second segment of the TB is transmitted in the second set of slots based on the second grant being associated with the HARQ process and the second segment of the TB not being transmitted from the first set of slots.

23. The method of claim 21, further comprising segmenting the TB into the first segment and the second segment.

24. The method of claim 21, wherein determining that the second subset of the first set of slots is unavailable for uplink transmission is based on one or more of a slot format indicator (SFI) or a cancellation indication.

25. The method of claim 21, wherein the first grant is received via a first downlink control information (DCI) and the second grant is received via a second DCI.

26. The method of claim 21, wherein transmitting the second segment of the TB in the second set of slots is further based on one or more of an indicator comprised in the second grant, a number of slots in the second set of slots being equal to a number of slots associated with the second segment of the TB, or a size of the second grant.

27. The method of claim 26, wherein the indicator is a new data indicator (NDI).

28. The method of claim 21, wherein the second set of slots is a same number of slots as the second subset of the first set of slots.

29. A wireless transmit/receive unit (WTRU) comprising:
a processor configured to:
receive, from a network, a first grant for a first set of slots, wherein the first grant is associated with a hybrid automatic repeat request (HARQ) process;
determine that a first subset of the first set of slots is available for uplink transmission and that a second subset of the first set of slots is unavailable for uplink transmission;
transmit a first segment of a transport block (TB) in the first subset of the first set of slots;
receive, from the network, a second grant for a second set of slots, wherein the second grant is associated with the HARQ process; and
transmit a second segment of the TB in the second set of slots based on the second grant being associated with the HARQ process.

30. The WTRU of claim 29, wherein the second segment of the TB is not sent in the first set of slots, and the processor is configured to transmit the second segment of the TB in the second set of slots based on the second grant being associated with the HARQ process and the second segment of the TB not being transmitted from the first set of slots.

31. The WTRU of claim 29, wherein the processor is further configured to segment the TB into the first segment and the second segment.

32. The WTRU of claim 29, wherein the processor is configured to determine that the second subset of the first set of slots is unavailable for uplink transmission based on one or more of a slot format indicator (SFI) or a cancellation indication.

33. The WTRU of claim 29, wherein the first grant is received via a first downlink control information (DCI) and the second grant is received via a second DCI.

34. The WTRU of claim 29, wherein the processor being configured to transmit the second segment of the TB in the second set of slots is further based on one or more of an indicator comprised in the second grant, a number of slots in the second set of slots being equal to a number of slots associated with the second segment of the TB, or a size of the second grant.

35. The WTRU of claim 34, wherein the indicator is a new data indicator (NDI).

36. The WTRU of claim 29, wherein the second set of slots is a same number of slots as the second subset of the first set of slots.

37. A base station (BS) comprising:
a processor configured to:
transmit, to a wireless transmit/receive unit (WTRU), a first grant for a first set of slots, wherein the first grant is associated with a hybrid automatic repeat request (HARQ) process, and wherein the first set of slots comprises a first subset that is available for uplink transmission and a second subset;
transmit, to the WTRU, an indication that the second subset of the first set of slots is unavailable for uplink transmission;
receive, from the WTRU, a first segment of a transport block (TB) in the first subset of the first set of slots;
transmit, to the WTRU, a second grant for a second set of slots, wherein the second grant is associated with the HARQ process; and
receive, from the WTRU, a second segment of the TB in the second set of slots based on the second grant being associated with the HARQ process.

38. The BS of claim 37, wherein the indication that the second subset of the first set of slots is unavailable for uplink transmission comprises one or more of a slot format indicator (SFI) or a cancellation indication.

39. The BS of claim 37, wherein a number of slots in the second set of slots is equal to a number of slots associated with the second segment of the TB.

40. The BS of claim 37, wherein a first downlink control information (DCI) comprises the first grant and a second DCI comprises the second grant.
